(19) United States
(12) Patent Application Publication
(10) Pub. No.: US 2019/0216018 A1
(43) Pub. Date: Jul. 18, 2019

(54) AGRICULTURAL MOWING DEVICE

(71) Applicant: Underground Agriculture, LLC, Sycamore, IL (US)

(72) Inventor: Joseph D. Bassett, Sycamore, IL (US)

(21) Appl. No.: 16/359,174

(22) Filed: Mar. 20, 2019

Related U.S. Application Data
(63) Continuation-in-part of application No. 16/194,143, filed on Nov. 16, 2018.
Application No. 16/194,143 is a continuation-in-part of application No. 15/941,613, filed on Mar. 30, 2018.
Application No. 15/941,613 is a continuation-in-part of application No. 15/392,731, filed on Dec. 28, 2016.
(60) Provisional application No. 62/271,770, filed on Dec. 28, 2015.

(51) Int. Cl. A01D 75/00; A01D 34/07

(52) U.S. Cl. CPC A01D 75/004; A01D 34/07

(57) ABSTRACT

An agricultural mowing device includes a linkage assembly for attaching to a towing vehicle, and a shaft having an upper end coupled to the linkage assembly for being towed in a field between two adjacent rows of planted matter. The device further includes a primary cutting device mounted to a lower end of the shaft for cutting shorter plant material, and a secondary cutting device mounted near the upper end of the shaft for cutting taller plant material. The device also includes a sensor for sensing a desired cutting height of the planted matter and being communicatively coupled to the primary cutting device or the secondary cutting device, the sensing causing an adjustment along the shaft of the respective one of the primary cutting device or the second cutting device to cut the planted matter at the desired cutting height.

### CROSS-REFERENCE TO RELATED APPLICATIONS

This application is a continuation-in-part of U.S. patent application Ser. No. 16/194,143 (Attorney Docket No. 000105USP2), titled “Agricultural Mowing Device,” filed on Nov. 16, 2018, which is a continuation-in-part of U.S. patent application Ser. No. 15/941,613 (Attorney Docket No. 000105USP1), titled “Agricultural Mowing Device,” filed on Mar. 30, 2018, which is a continuation-in-part of U.S. patent application Ser. No. 15/392,731 (Attorney Docket No. 000105USPT), titled “Agricultural Organic Device for Weed Control,” filed on Dec. 28, 2016, which in turn claims priority to U.S. Provisional Patent Application No. 62/271,770 (Attorney Docket No. 000105PL01) titled “Agricultural Organic Device For Weed Control,” filed on Dec. 28, 2015, each of which is incorporated herein by reference in its respective entirety.

### FIELD OF THE INVENTION

The present invention relates generally to agricultural equipment and, more particularly, to a mowing device with an inter-row cutting unit for mowing between adjacent crop rows in a field containing a planted crop.

### SUMMARY OF THE INVENTION

According to one embodiment of the present disclosure, an agricultural mowing device includes a linkage assembly for attaching to a towing vehicle, and a shaft having an upper end coupled to the linkage assembly for being towed in a field between two adjacent rows of planted matter. The device further includes a primary cutting device mounted to a lower end of the shaft for cutting shorter plant material, and a secondary cutting device mounted near the upper end of the shaft for cutting taller plant material. The device also includes a sensor for sensing a desired cutting height of the planted matter and being communicatively coupled to the primary cutting device or the secondary cutting device, the sensing causing an adjustment along the shaft of the respective one of the primary cutting device or the second cutting device to cut the planted matter at the desired cutting height.

According to another embodiment of the present disclosure, an agricultural mowing device includes a linkage assembly for attaching to a towing vehicle, and a shaft having an upper end coupled to the linkage assembly for being towed in a field between two adjacent rows of planted matter. The device further includes a cutting device mounted to the shaft for cutting plant material, the cutting device extending laterally from the shaft to a distance covering at least a portion of at least one of the two adjacent rows for cutting the plant matter that grows in the at least one of the two adjacent rows. The device also includes a sensor for sensing a desired cutting height of the planted matter and being communicatively coupled to the cutting device, the sensing causing an automatic adjustment along the shaft of the cutting device to cut the plant matter at the desired cutting height.

According to yet another embodiment of the present disclosure, a method is directed to cutting plant matter with an agricultural mowing device and includes attaching a linkage assembly to a towing vehicle. The method further includes advancing the linkage assembly in a field of planted matter with a shaft being positioned between two adjacent rows of the planted matter, the shaft having an upper end coupled to the linkage assembly. The method further includes cutting with a primary cutting device shorter plant material that grows between the two adjacent rows, the primary cutting device being mounted to a lower end of the shaft, and cutting with a secondary cutting device taller plant material that grows at least in part in at least one of the two adjacent rows, the secondary cutting device being mounted near the upper end. The method also includes sensing with one or more sensors a desired cutting height of the shorter plant material or the taller plant material, and, based on the sensing, automatically adjusting at least one of the primary cutting device or the secondary cutting device to the desired cutting height.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The invention may best be understood by reference to the following description taken in conjunction with the accompanying drawings.

FIG. 1 is a perspective view illustrating an organic device with a single weed-control unit and a single motor.

FIG. 2 is a perspective view illustrating an agricultural system with multiple weed-control units driven by a single motor.

FIG. 3 is a side view illustrating an agricultural system with an agricultural vehicle attached to a weed-control unit having a single motor and a front gauge wheel.

FIG. 4 is a rear view illustrating height adjustment of weed-control units.

FIG. 5 is a perspective view illustrating weed-control units with front and rear gauge wheels.

FIG. 6 is a rear view illustrating pivoting movement of weed-control units.

FIG. 7 is a perspective view illustrating spring-loaded weed-control units with front and rear gauge wheels.

FIG. 8 is a top view illustrating single weed-control units with respective motors.

FIG. 9 is a rear view illustrating pivoting movement of weed-control units with a spring-loaded element.

FIG. 10 is a top perspective view illustrating an agricultural mowing device.

FIG. 11 is a bottom perspective view of the agricultural mowing device shown in FIG. 10.

FIG. 12 is an enlarged side elevation view of the agricultural mowing device shown in FIG. 10.

FIG. 13 is a sectional view taken along a longitudinal section taken along a longitudinal plane extending through the center of the agricultural mowing device shown in FIG. 10.

FIG. 14 is an end elevation taken from the front end of the agricultural mowing device shown in FIG. 10.

FIG. 15 is an enlarged section taken along line 15-15 in FIG. 12.

FIG. 16 is an enlarged section taken along line 16-16 in FIG. 12 with the mowing device turned upside down.

FIG. 17 is an enlarged perspective view taken from the bottom of the mowing blades in the agricultural mowing device shown in FIG. 10.

FIG. 18 is a top view of the agricultural mowing device shown in FIG. 10.

FIG. 19A is an enlarged perspective view illustrating two pairs of mowing blades in the agricultural mowing device shown in FIG. 10.

FIG. 19B is an enlarged perspective view illustrating one pair of mowing blades in the agricultural mowing device shown in FIG. 10 in a first orientation.

FIG. 19C is an enlarged perspective view illustrating one pair of mowing blades in the agricultural mowing device shown in FIG. 10 in a second orientation.

FIG. 19D is an enlarged perspective view illustrating one pair of mowing blades in the agricultural mowing device shown in FIG. 10 in a third orientation.

FIG. 20 illustrates a mower attached to a front end of a high-clearance sprayer type vehicle.

FIG. 21 is a side elevation view illustrating an agricultural mowing device with a primary weed-control unit and a secondary weed control unit.

FIG. 22 is a front elevation view illustrating the agricultural mowing device shown in FIG. 21.

FIG. 23 is a top perspective view illustrating the agricultural mowing device shown in FIG. 21.

FIG. 24 is a bottom perspective view illustrating the agricultural mowing device shown in FIG. 21.

FIG. 25A illustrates a front elevation view of the agricultural mowing device shown in FIG. 21 prior to mowing a set of plant matter.

FIG. 25B illustrates a front elevation view of the agricultural mowing device shown in FIG. 21 after mowing a set of plant matter.

FIG. 26 is a bottom view illustrating the agricultural mowing device shown in FIG. 21 attached to a mounting frame.

FIG. 27 is a side elevation view illustrating an agricultural mowing system with a plurality of agricultural mowing devices shown in FIG. 21.

FIG. 28 is a rear elevation view illustrating the agricultural mowing system shown in FIG. 27.

FIG. 29 is a bottom view illustrating the agricultural mowing system shown in FIG. 27.

FIG. 30 is a side view illustrating an agricultural mowing device having primary and secondary weed-control units, with the secondary weed-control unit having a sensor at an initial height.

FIG. 31 is a side view illustrating the secondary weed-control unit of FIG. 30 cut unwanted weeds above a crop material based on sensor information.

FIG. 32 is a side view illustrating the secondary weed-control unit of FIG. 30 cut tops of the crop material based on sensor information.

FIG. 33 is a side view illustrating the primary weed-control unit of FIG. 30 in a non-cutting mode while the secondary weed-control unit is trimming the tops of the crop material.

FIG. 34 is a side view illustrating the secondary weed-control unit of FIG. 30 cut the crop material at a lower position based on sensor information.

FIG. 35 is a side view illustrating a proximity sensor for dense crop material.

FIG. 36 is a side view illustrating an electrical probe sensor for thick crop material.

FIG. 37 is a side view illustrating a rotational sensor.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

Turning now to the drawings and referring initially to FIG. 1, an organic device 100 is attachable to an agricultural towing vehicle, e.g., a tractor, for mowing and/or spraying weeds located between rows in a field of planted matter (e.g., crops). The device 100 includes a vertically adjustable shaft 102 that is attached, at an upper end 104, to the towing vehicle via an attachment link 106 and, at a lower end 108, to a weed-control unit 110. The weed-control unit 110 includes a dedicated motor 112 and a rotatable cutting blade 114. By way of example, the motor 112 is a hydraulic or electric motor. The device 100 further includes a sprayer input with one or more sprayer input tubes 116 that are coupled to an end of the weed-control unit 110 for delivering weed-control and/or other substances.

The device 100 is advanced between adjacent rows of planted matter, such as a left row 120 and a right row 122 of plants 124 in a field 126. As the device 100 is advanced, it mows growing weeds 128 with the cutting blade 114 to clear a reduced or weed-free path 130 between the rows 120, 122. In addition to, or instead of, the mowing achieved by the cutting blade 114, the device 100 further outputs one or more weed-control substances from the sprayer input tubes 116. The weed-control substance is helpful in reducing and/or preventing the reappearance of weeds in the path 130.

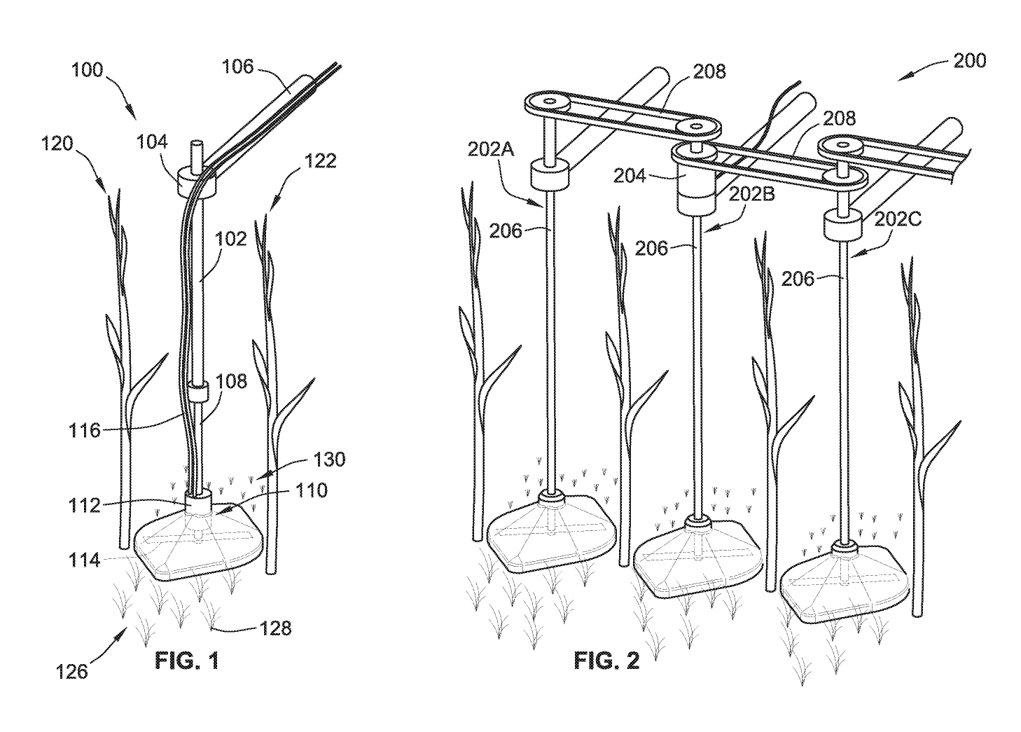

Referring to FIG. 2, an agricultural system 200 includes multiple organic devices 202 driven by a single motor 204. The organic devices 202 include a left device 202A, a center device 202B, and a right device 202C, with each device having a respective shaft 206. In this example, the shaft 206 has a fixed height, with all the devices 202 having the same height.

The motor 204 is mounted to an upper end of the shaft 206 of the center device 202B. In turn, each upper end of the left and right devices 202A, 202C is coupled via a respective rotating belt or chain 208 to the center device 202B. As such, the single motor 204 drives all the devices 202 simultaneously, and is located in the center of the device so that the edges can be located as close to the planted crop as possible.

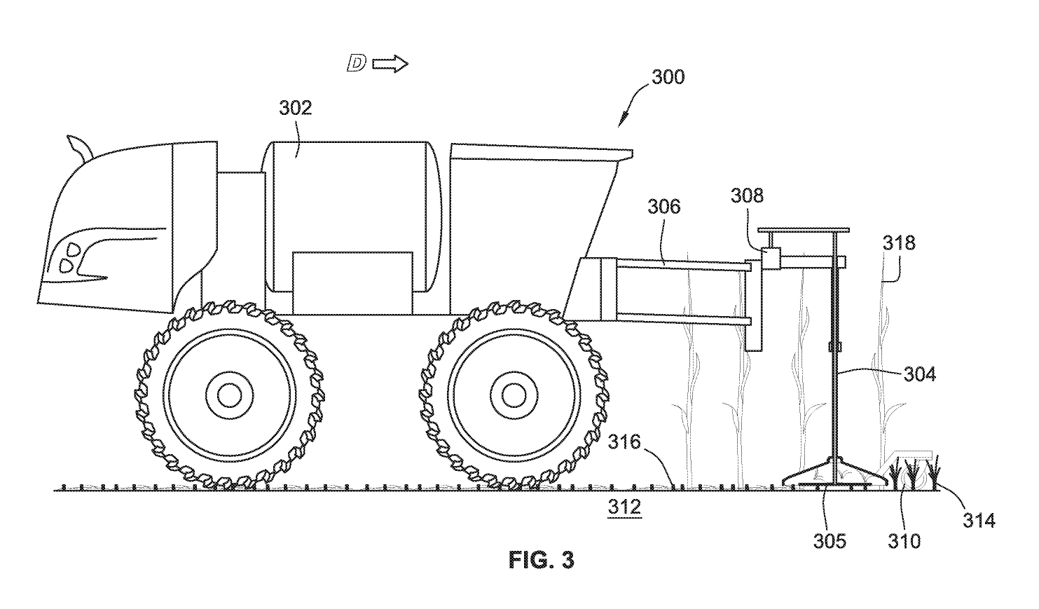

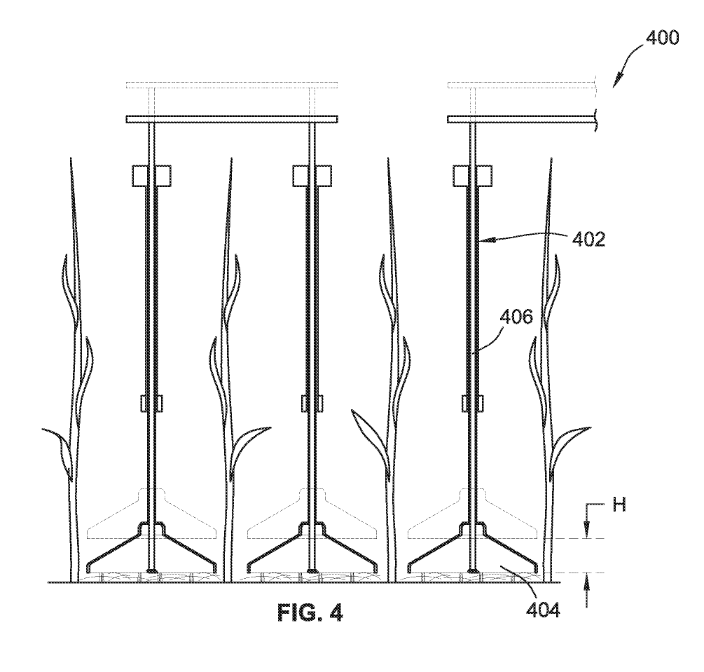

Referring to FIG. 3, an agricultural system 300 has an agricultural vehicle 302 that is attached to an organic device 304 via a frame linkage 306. The device 304 has a weed-control unit 305, a single motor 308, and a front gauge wheel 310. As the device 304 advances in a direction D along a field 312, growing weeds 314 are mowed and/or treated with weed-control substances to achieve a generally weed-free or reduced-weed path 316 between the rows of planted matter 318.

Referring to FIG. 4, an agricultural system 400 has a plurality of organic devices 402 with respective weed-control units 404 and shafts 406. The shafts 406 are adjustable, having an H range of positions, in accordance with a weed height present in the field. As applicable, the devices 402 are generally similar (but not necessarily identical) to and include one or more components of the devices 100, 202, and 304 described above and illustrated in FIGS. 1-3.

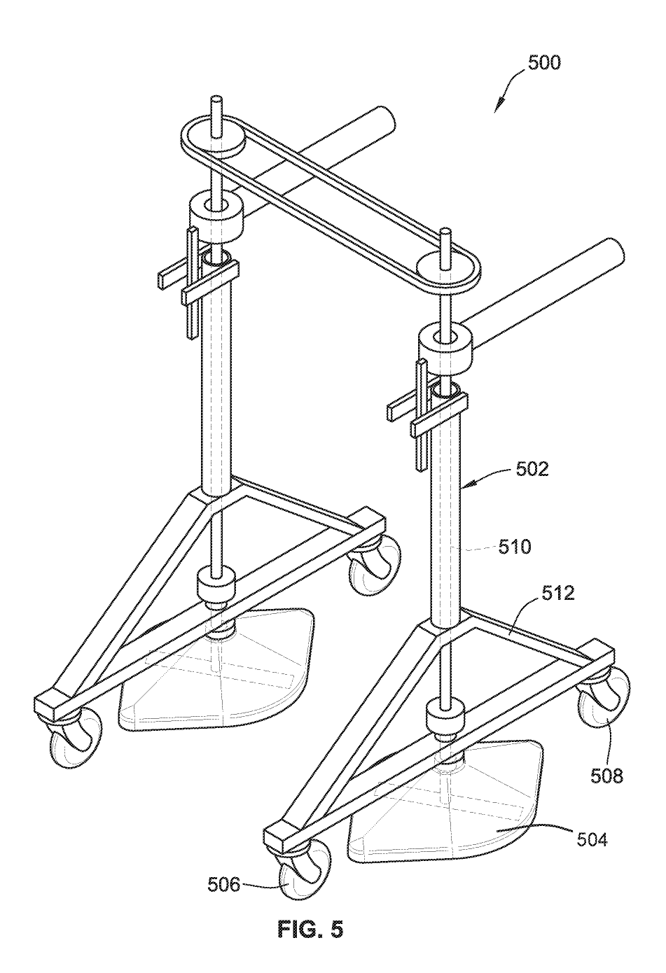

Referring to FIG. 5, an agricultural system 500 has a plurality of organic devices 502 with respective weed-control units 504. Each device 502 has a pair of gauge wheels that includes a front gauge wheel 506 and a rear gauge wheel 508. The gauge wheels 506, 508 are mounted to a shaft 510 via a gauge frame 512.

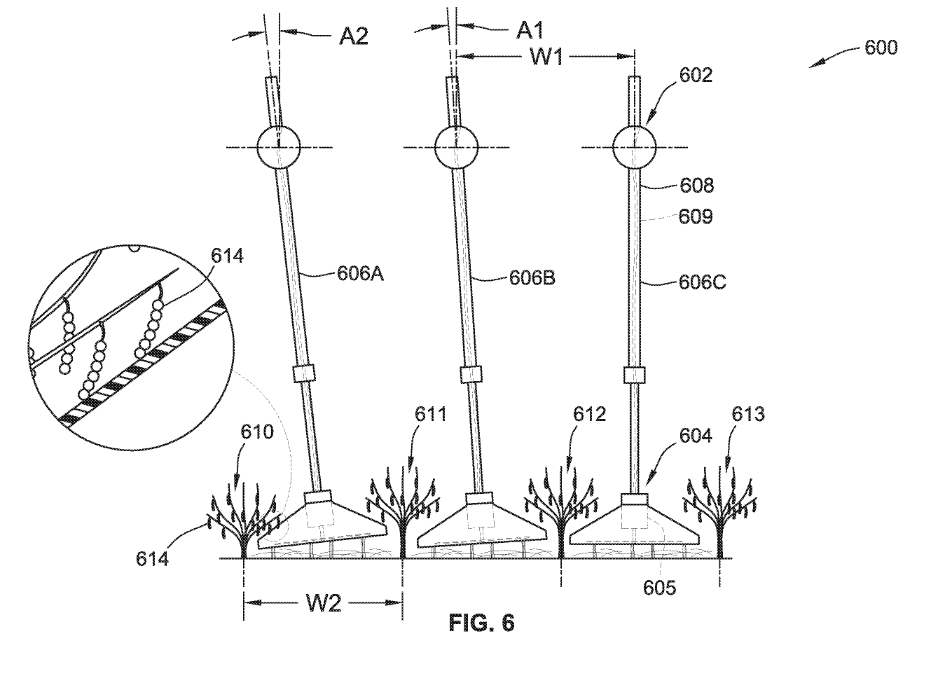

Referring to FIG. 6, an agricultural system 600 has a plurality of pivotable organic devices 602 with respective weed-control units 604 and motors 605. The weed-control units 604 are attached to lower ends of respective shafts 606, which include an outer protective shield 608 and an internal substance-insertion tube 609. The shafts 606 are independently pivotable at various angles, such as angles A1 and A2, with each shaft 606 pivoting between respective rows 610-613 of plants 614. For example, a left shaft 606A pivots at an angle A2 between a first row 610 and a second row 611, while a center shaft 606B simultaneously pivots at an angle A1 between the second row 611 and a third row 612.

The pivoting feature allows the devices 602 to be spaced across rows at distances that are not necessarily the same width. For example, a right shaft 606C is spaced away from the center shaft 606B at a width W1 that is greater than the space by which the left shaft 606A is spaced away from the center shaft 606B (at a smaller width W2).

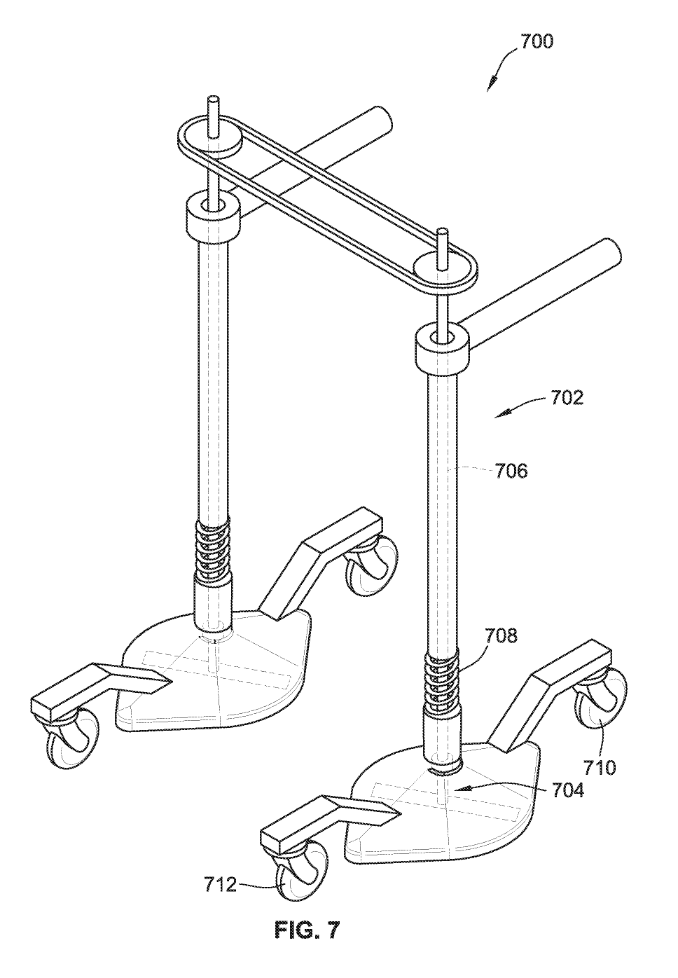

Referring to FIG. 7, an agricultural system 700 has a plurality of organic devices 702 with respective weed-control units 704. Each organic device 702 has a shaft 706 with a spring-loaded element 708 at a lower end that is attached to the weed-control unit 704. The spring-loaded element 708 allows automatic adjustment of the weed-control unit 704 when passing over uneven terrain or weeds. The weed-control units 704 further include a pair of front and rear gauge wheels 710, 712.

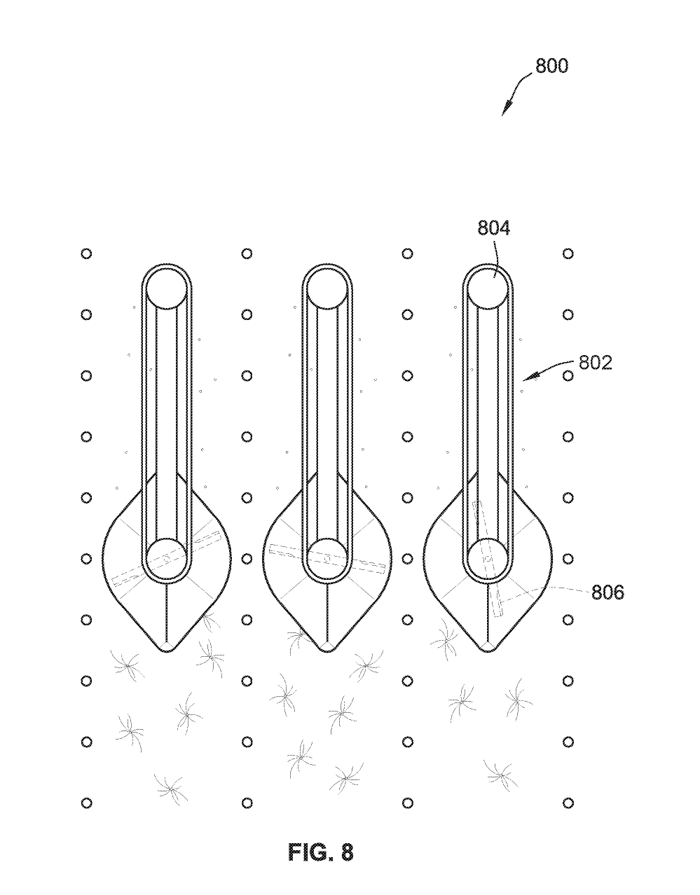

Referring to FIG. 8, an agricultural system 800 has a plurality of organic devices 802 with respective motors 804. The devices 802 have cutting blades 806 that are independently powered, respectively, by the motors 804.

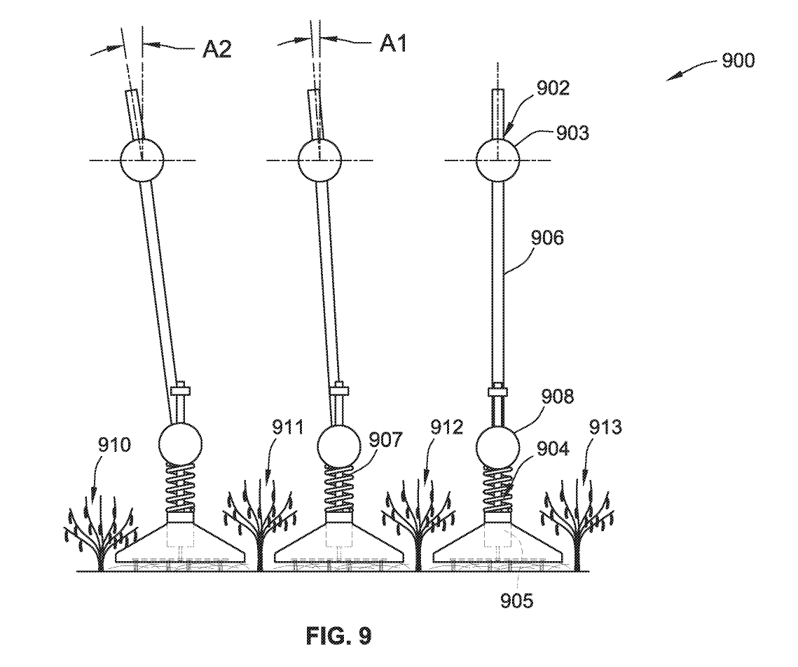

Referring to FIG. 9, an agricultural system 900 has a plurality of pivotable organic devices 902 with respective weed-control units 904 and motors 905. The weed-control units 904 are attached to lower ends of respective shafts 906, which are independently pivotable at various angles (such as angles A1 and A2). A spring-loaded element 907 is mounted at the lower end of each shaft 906 to allow self-adjustment of the weed-control unit 904 over uneven terrain or weeds. As the agricultural system 900 is advanced, it mows down growing weeds 910-913 to clear reduced or weed-free paths between adjacent rows of planted matter.

The pivoting motion of the devices 902 is achieved, in part, by a top bearing element 903 and/or a bottom bearing element 908. The bottom bearing element 908, which is at a fixed distance from the top bearing element 903, allows the weed-control unit 904 to float parallel to the ground (in response to the weight of the weed-control unit 904). The height of the weed-control unit 904 is optionally maintained at a desired height via gauge wheels. Alternatively, according to another example, the height of the weed-control unit 904 is maintained via a motor drive unit mounted inside the shaft 906 or inside the bottom bearing element 908.

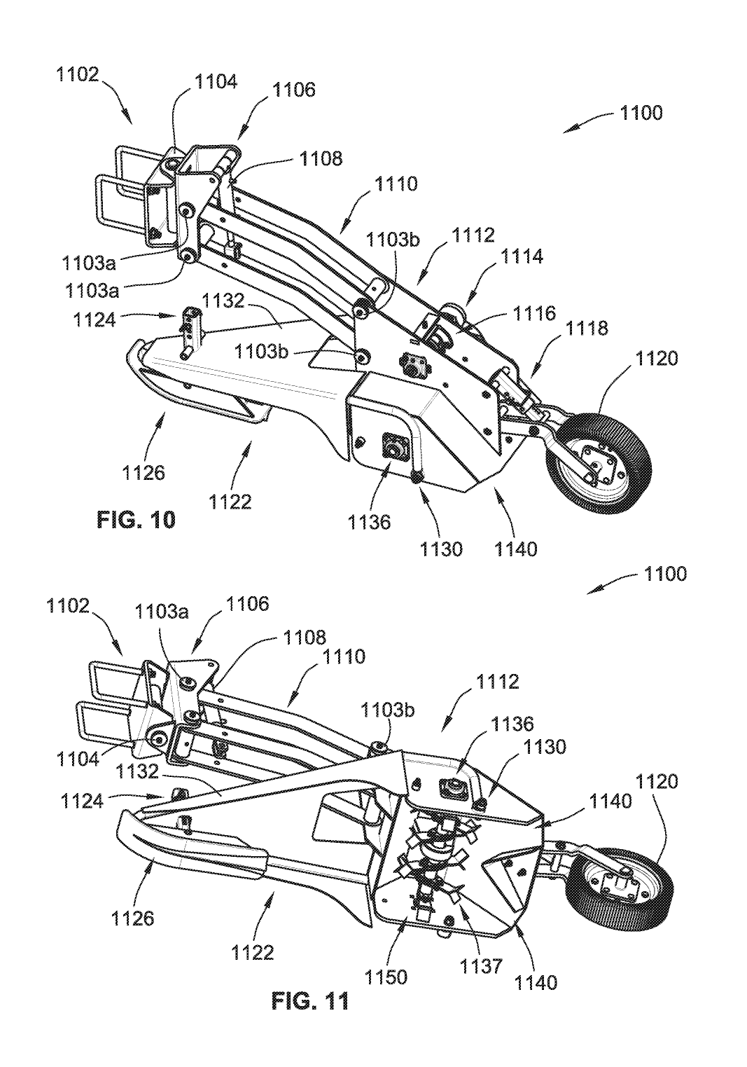

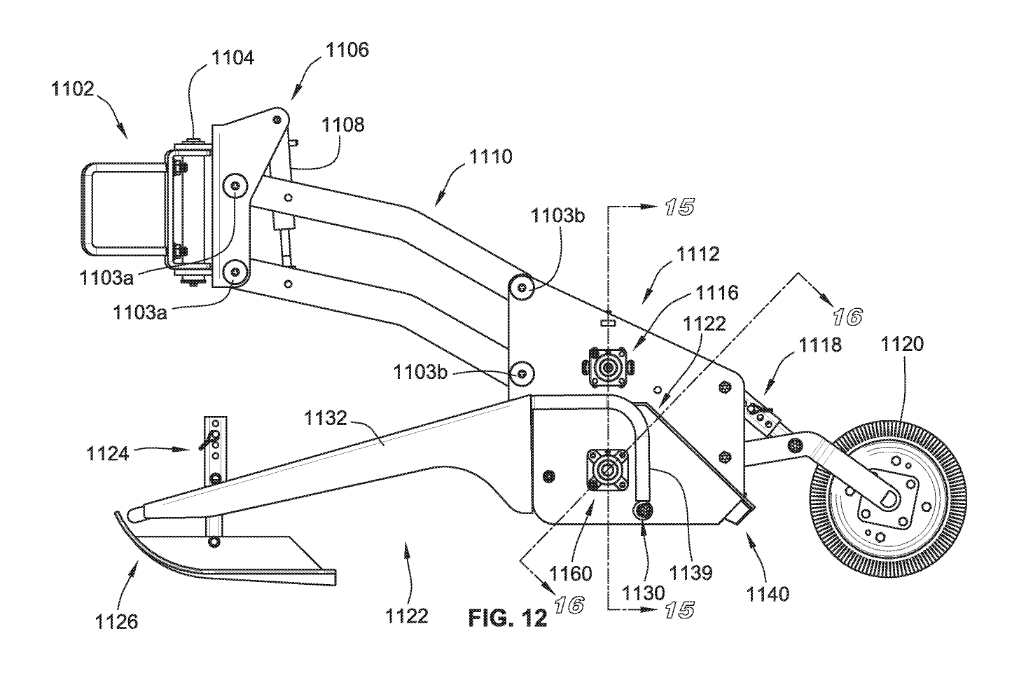

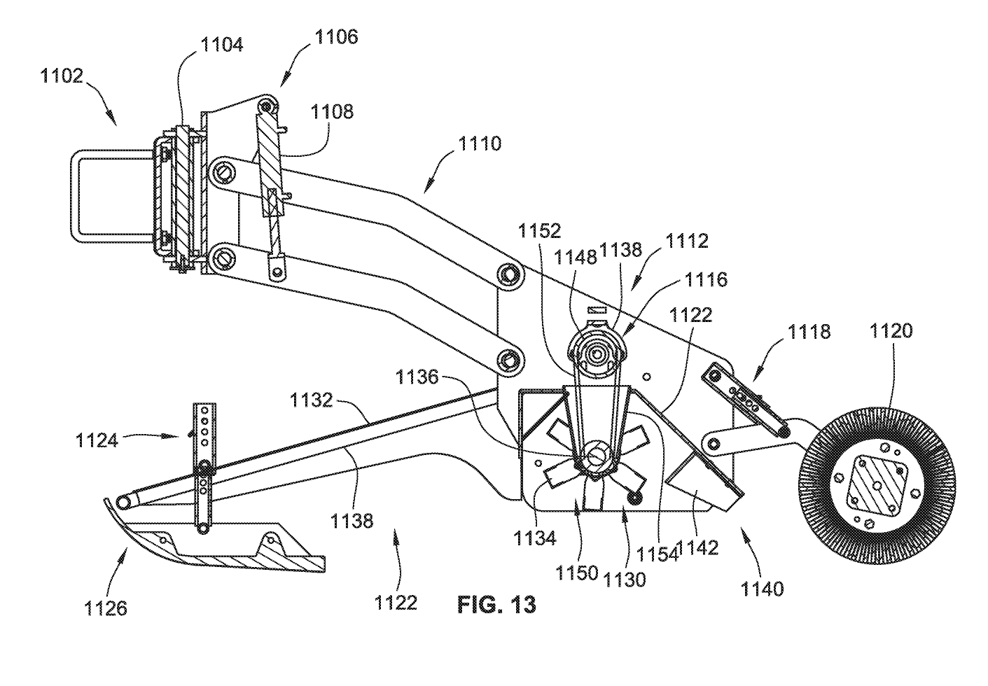

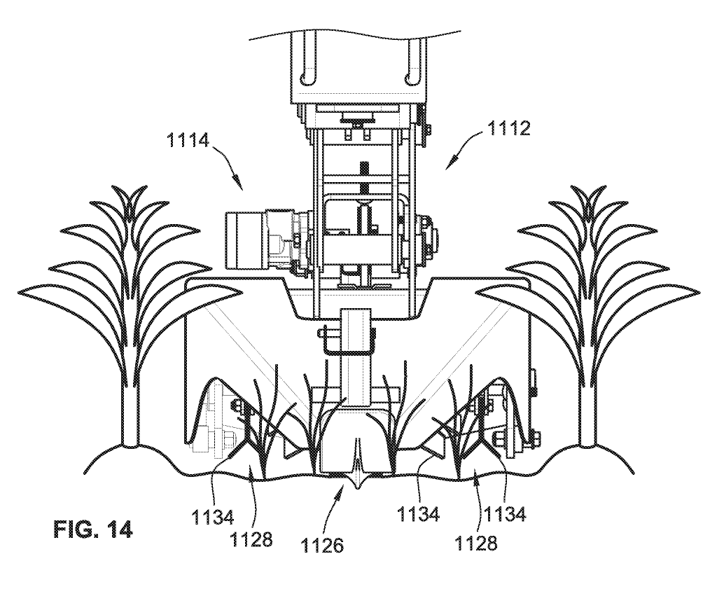

While features illustrated in FIGS. 1-9 are combinable in a single embodiment, FIGS. 10-18 illustrate a modified mowing device 1100 that includes a 4-bar linkage 1110 for attaching a cutting device 1112 to a tractor by a mounting assembly 1102. As best shown in FIGS. 10-11, a vertical pivot pin 1104 in the mounting assembly 1102 permits the 4-bar linkage 1110, and thus the cutting device, to be pivoted horizontally relative to the tractor. Two pairs of horizontal pivot pins 1103a and 1103b at opposite ends of the 4-bar linkage 1110 permit that linkage to be pivoted vertically relative to the mounting assembly 1102. A hydraulic cylinder 1108 connected between the mounting assembly 1102 and the 4-bar linkage 1110 applies a controllable down pressure on the 4-bar linkage 1110 and thus on the cutting device 1112.

Referring to FIGS. 10-14, the cutting device 1112 includes a housing that is supported between a skid 1126 on the front and a rear wheel 1120 that is able to be adjusted up and down with a height adjustment assembly 1118 that is one part of the height setting of the blade assemblies 1137. The housing contains a shaft 1136 that carries four pairs of blade assemblies 1137 for cutting off weeds or other material at a level just slightly above the ground surface, in the area between adjacent rows of a planted crop, without cutting the crop plants. The shaft 1136 that carries the blade assemblies 1137 is driven by a motor 1114 mounted on the outside surface of one of the side walls of the housing. The side walls are pivoted on the lower front ends of rods 1138 and 1139 that also support the front portion of the top wall 1132 of the housing, which is narrow enough to fit between adjacent rows of a planted crop. The pivoted mounting of the housing permits the tapered front wall of the housing to float upwardly over obstacles, and the front skid 1126 and the rear wheel 1120 enable the device 1112 to float over the surfaces of such obstacles. The tapered front end of the housing allows it to run in canopied crops.

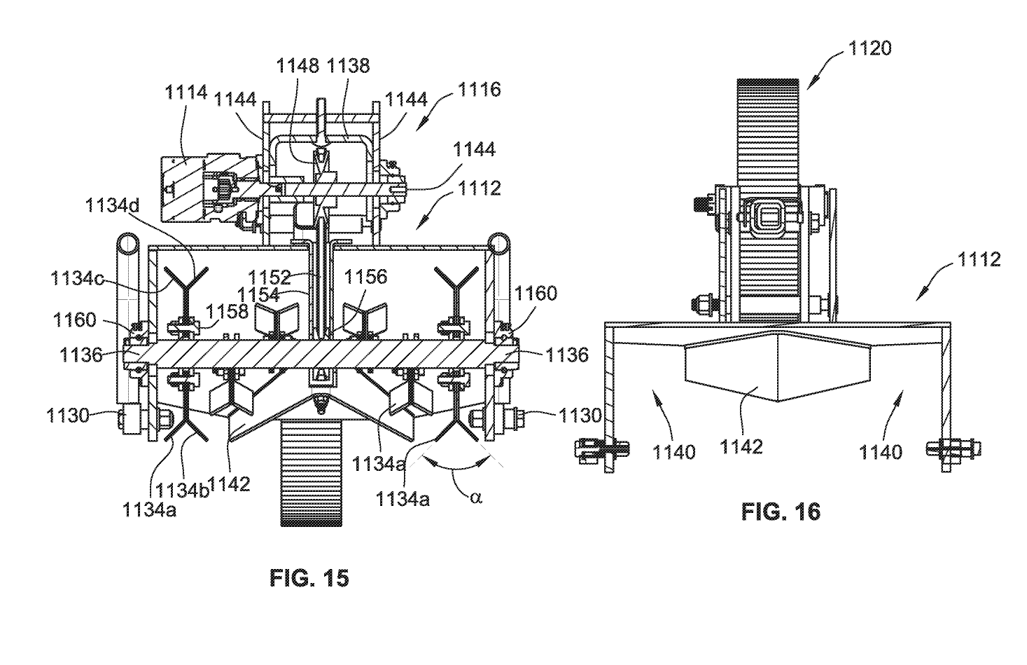

The blade assemblies 1137 preferably include flail blades 1134 to deal with relatively heavy grass or scrub, particularly where contact with loose debris may be possible. As depicted in FIGS. 15 and 16, adjacent pairs of the flail blades 1134 in the blade assemblies 1137 are staggered with respect to each other to provide a complete cut. The flail blades 1134 are shaped like a “T” or “Y.” If a flail blade strikes an immovable object, it simply bounces off,

The cutting device 1112 has a front shield 1122 with a top wall 1132 that helps guide the mower assembly in turns because the skid 1126 does not turn in reference to the main assembly 1112. The rods 1138 and 1139 that support the front shield 1122 are connected to the cutting device 1112 via pivot points 1130, which allows the shield to move up and down with the ground, and pushes the planted crop (e.g., corn, beans and other crops) away from the mower.

As best shown in FIG. 15, the flail blades 1134 are driven by a motor 1114 connected to a shaft 1144 which turns an upper pulley 1148, and a belt or chain 1152 within a shield 1154 turns a tiller blade pulley 1156 that is connected to a tiller blade shaft 1136. The motor 1114 may be a hydraulic or electric motor, or could be replaced with a PTO driveshaft or a ground drive.

This blade shaft 1136 has pivot bolts 1158 mounted on it with cutting blades 1134 that pivot around the bolts, this allows the cutting blades 1134 to hit a weed, for example, and grab the weed and move at a different speed than the shaft 1136.

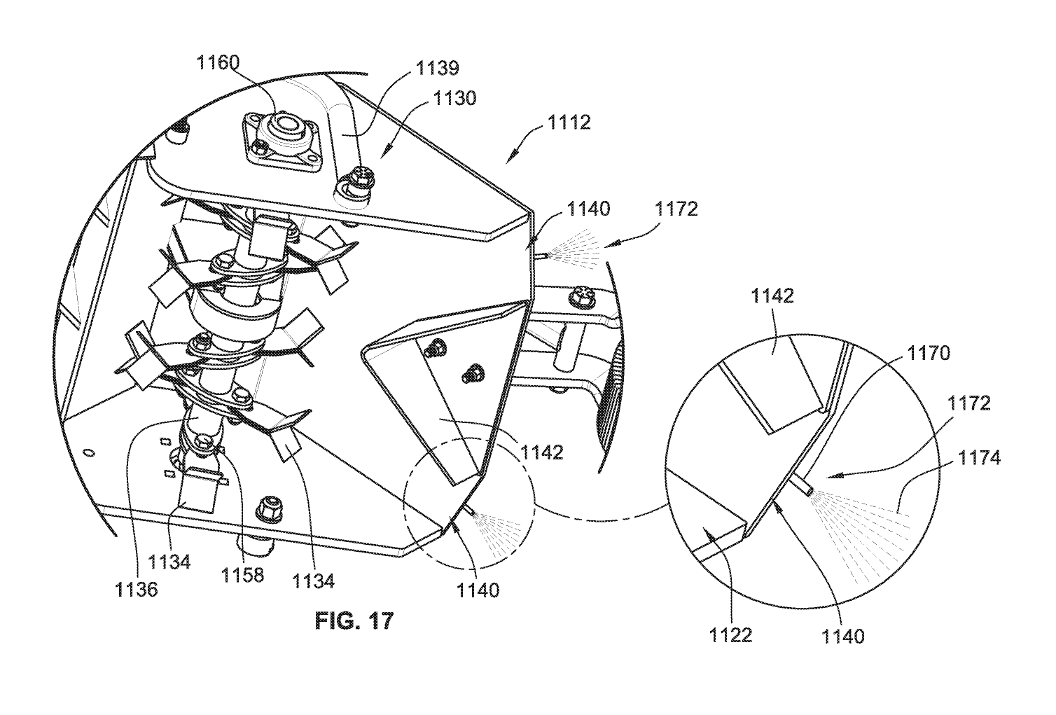

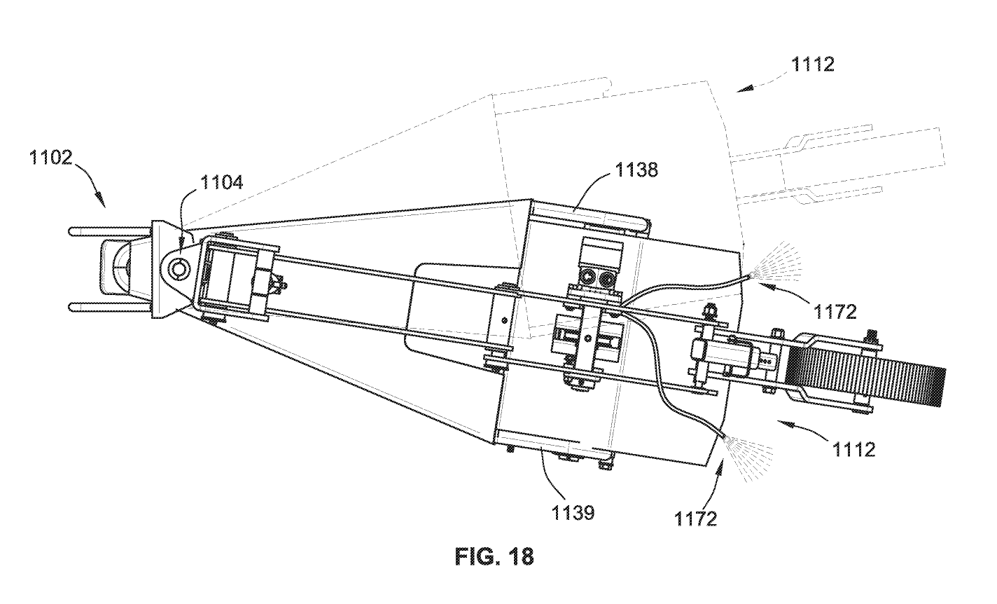

As best shown in FIG. 16, the material cut by the flail blades 1134 is discharged rearwardly into a rear discharge area 1140 where a deflector 1142 guides the mowed clippings to both of the adjacent rows of planted crop, to provide sun coverage and/or to decompose and feed both rows of planted crop. This covers the roots of the crop plants to provide shade and additional weed control within the planted rows. Referring to FIGS. 17-18, the cutting device 1112 further includes a sprayer input 1172 with one or more sprayer input tubes 1170 that are coupled to an end in the cutting device 1112 for delivering weed-control and/or other substances 1174.

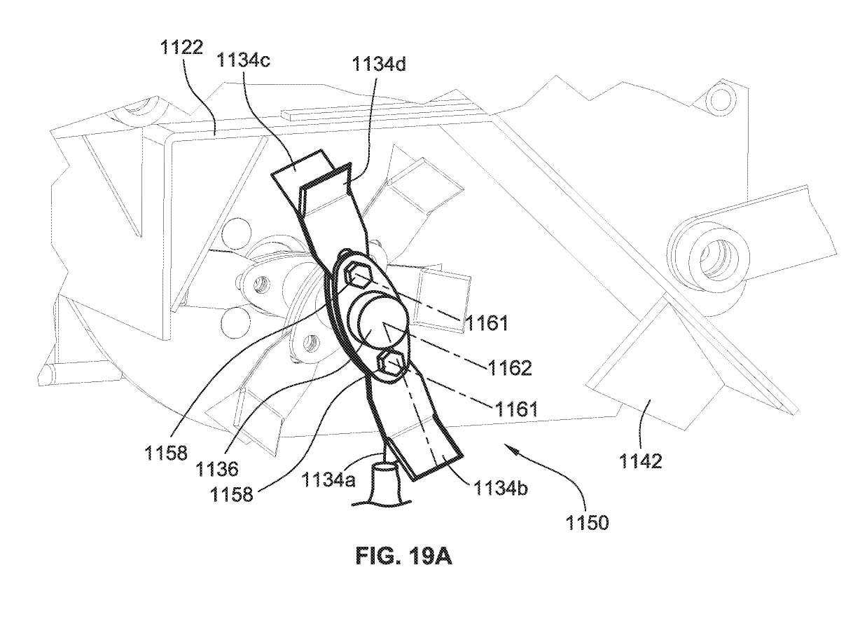

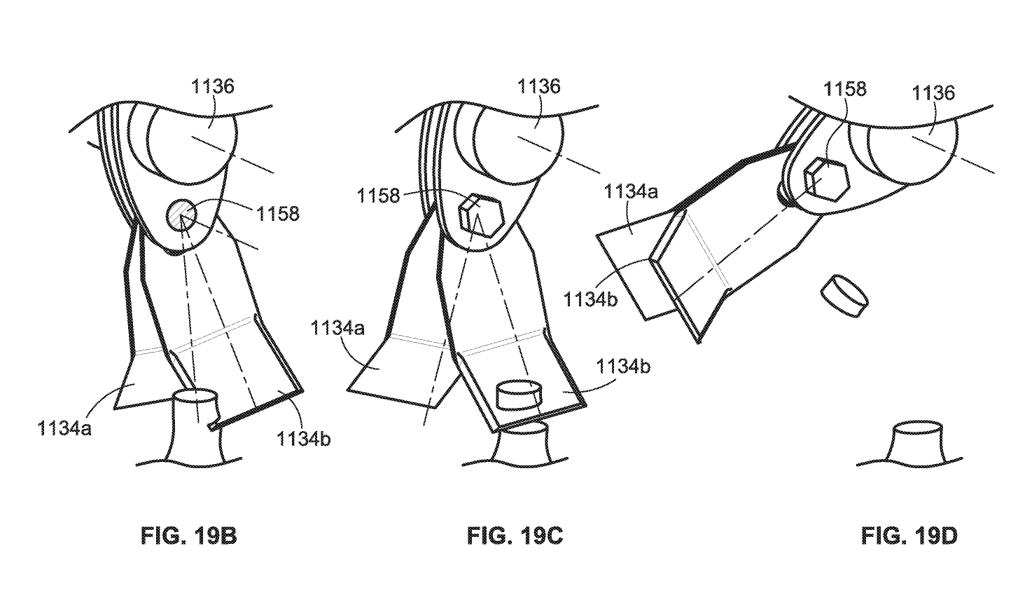

Referring to FIGS. 19A-D, each blade assembly 1137 has two pairs of flailing cutters 1134 mounted on opposite ends of the blade assembly 1137. The other portions of each pair of flailing cutters are bent away from each other. The inner end portions of the cutters have elongated apertures through which fastening bolts 1161 pass to attach the cutters between a pair of an elliptical plate 1162 attached to a driven shaft 1158. Thus, the rotating shaft 1158 rotates each pair of cutters 1134 in a vertical circular path, so that the bent portions pass repeatedly over the surface of the soil. The side edges of the bent portions of the cutters thus slice the stems and leaves of any weeds or other material in the area between adjacent rows of the planted crop.

A flail mower is a type of powered garden/agricultural equipment, which is used to deal with heavier grass/scrub which a normal lawn mower could not cope with. Some smaller models are self-powered, but many are PTO driven implements, which can attach to the three-point hitches found on the rear of most tractors. This type of mower is best used to provide a rough cut to taller grass where contact with loose debris may be possible such as roadsides.

The flail mower gets its name from the use of “flails” attached to its rotating horizontal drum (also called tube, rotor, or axle). Many implement companies also refer to the flails as knives or blades. The rows of flails are usually staggered to provide a complete cut. The flails are attached to the drum using chain links or brackets, depending on the manufacturer. The rotating drum is perpendicular to the axis of the tractor. The PTO driveshaft along the tractor's axis must make a right angle through the use of a gearbox in order to transfer its rotational energy to the drum. As the drum rotates, centrifugal force pushes the flails outward.

Standard flails are shaped like an extruded “T” or “Y” and a chain attaches to the bottom. There are also proprietary flails with various shapes for shredding larger brush and others that leave a smooth, finish cut.

If a flail strikes an immovable object, it simply bounces off. Other rotary type mowers have a tendency to grab and throw the object out of the mower deck if its small enough. This fact makes the flail mower best suited for areas where thrown objects would cause damage.

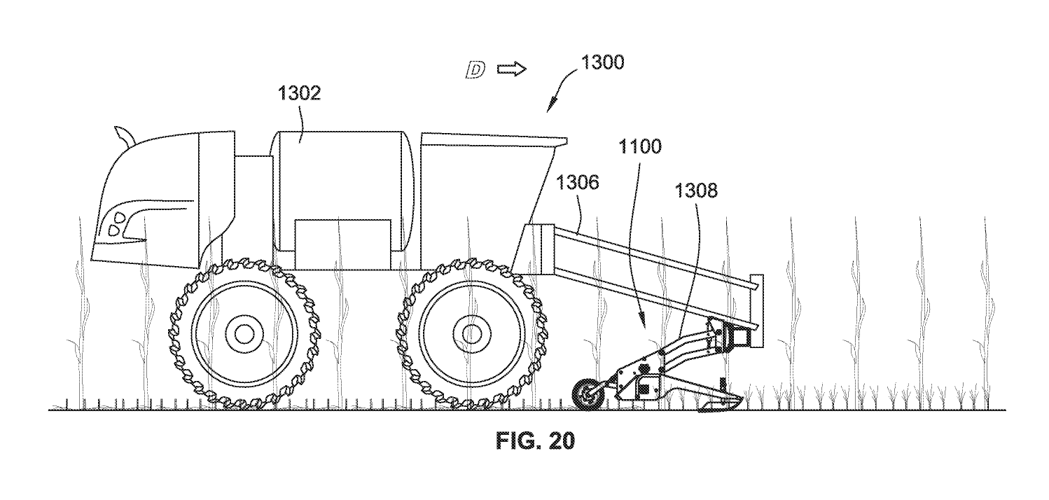

FIG. 20 illustrates the mower attached to the front end of a high-clearance sprayer type vehicle 1300. The mower is mounted om a controllable support arm 1306 projecting from the front end of the vehicle 1300, so that the mower 1100 can be raised above the height of planted crops so that the mower does not mow crop plants at the end of a field. For example, the height of the mower can be controlled in response to a GPS signal and/or an optical camera row steering system.

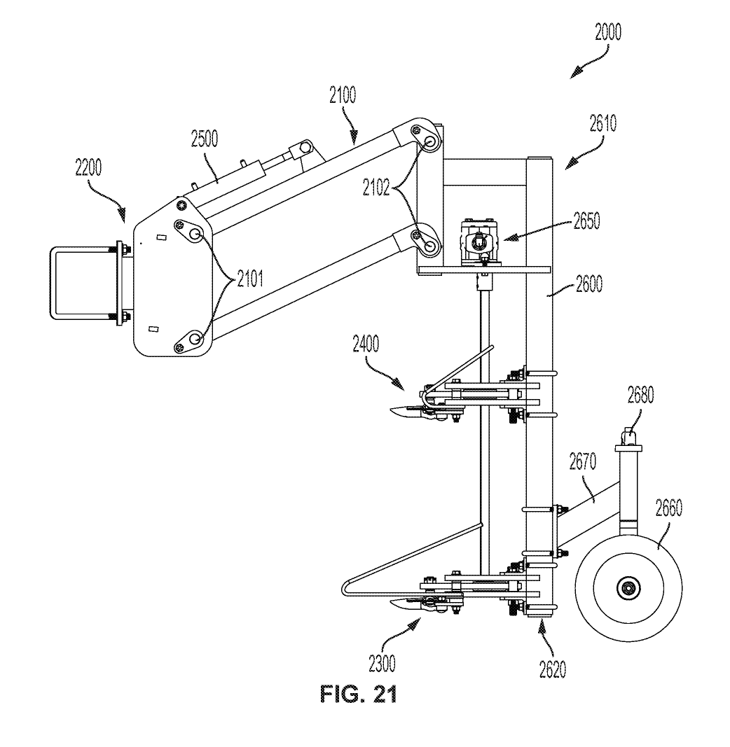

Referring generally to FIGS. 21-26, an agricultural mowing device 2000 includes a primary weed-control unit 2300 for cutting material (e.g., weeds) between the rows in a planted field of crops (e.g., corn, soybeans, etc.), the same as or similar to implementations illustrated in FIGS. 10-20, except that the agricultural mowing device 2000 further includes a secondary weed-control unit 2400 for inter-row removal of unwanted material (e.g., weeds and/or other crops that grow among the rows in the planted field of crops) that generally grow at a higher height than the planted crops in the row.

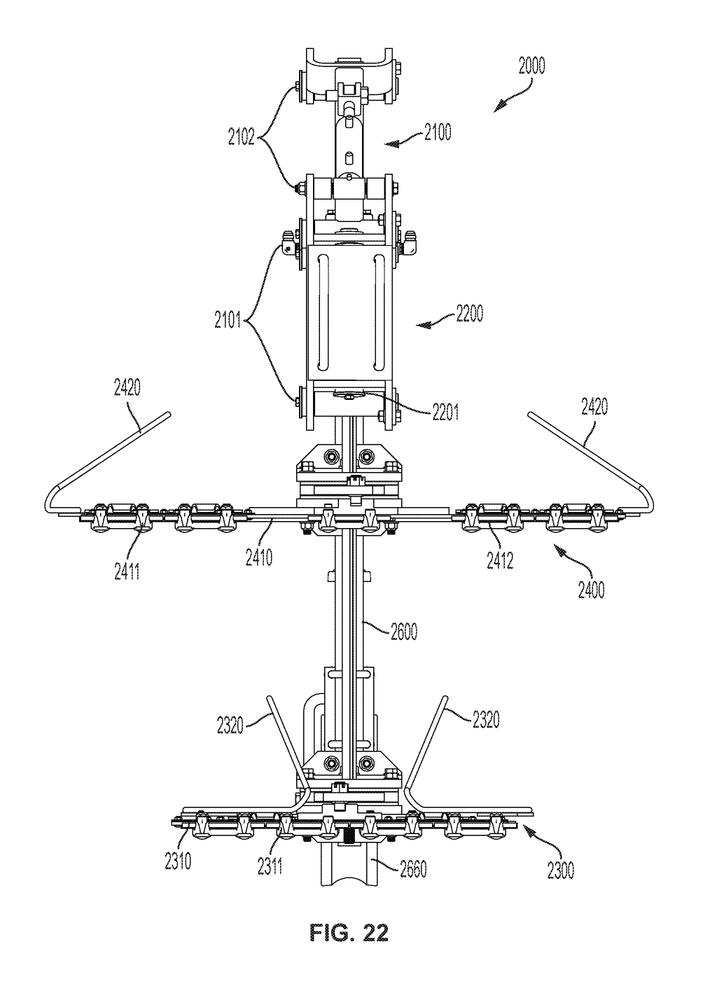

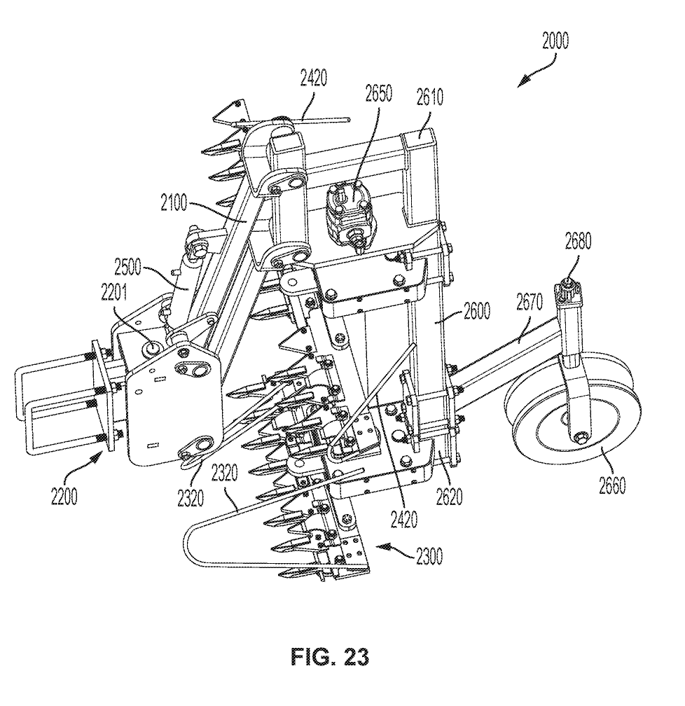

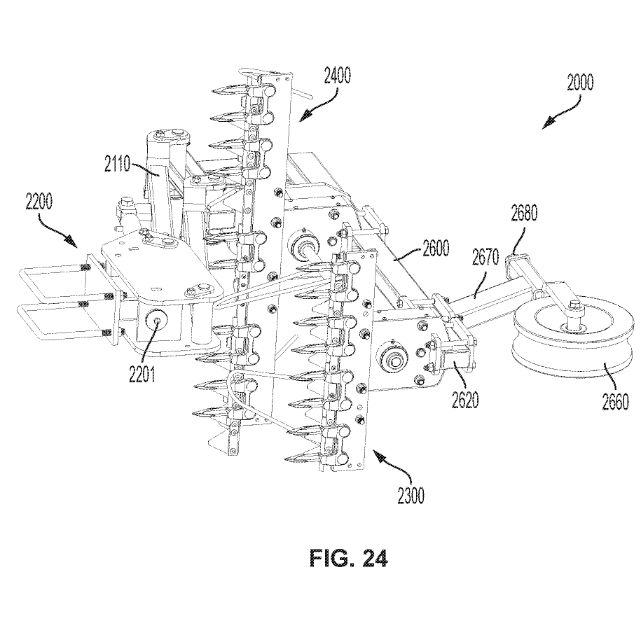

In some implementations, as best shown in FIGS. 21-24, the agricultural mowing device 2000 includes a linkage assembly 2100 for attaching a cutting device to a vehicle (e.g., tractor) by a mounting assembly 2200. The linkage assembly 2100 includes a four-bar linkage. A vertical pivot pin 2201 (FIGS. 23-24) in the mounting assembly 2200 permits the linkage assembly 2100, and thus the primary weed-control unit 2300 and the secondary mowing unit 2400, to be pivoted horizontally relative to the tractor. Two pairs of horizontal pivot pins 2101 and 2102 (FIGS. 21-22) at opposite ends of the linkage assembly 2100 permit that linkage assembly 2110 to be pivoted vertically relative to the mounting assembly 2200. A hydraulic cylinder 2500 connected between the mounting assembly 2200 and the linkage assembly 2100 applies a controllable down pressure on the linkage assembly 2100 and thus on the primary and secondary weed-control units 2300 and 2400.

The agricultural mowing device 2000 includes a vertically adjustable shaft 2600 that is attached to the linkage assembly 2100 at an upper end 2610, and to the primary weed-control unit 2300 at a lower end 2620. The adjustable shaft 2600 is also attached to the secondary weed-control unit 2400 between the upper end 2610 and the lower end 2620. The secondary weed-control unit 2400 is positioned at a height tall enough where secondary weed-control unit 2400 will cut off weeds or other material without cutting the planted crop plants. The primary and secondary weed-control units 2300 and 2400 are driven by a single motor 2650. By way of example, the motor 2650 is a hydraulic motor, an electric motor, an internal combustion engine, or the like, or in any combination thereof. Additionally or alternatively, the motor is mechanically connected to the PTO on a tractor, driving all at once. However, multiple motors are also contemplated to drive each of the weed-control units 2300 and 2400 separately.

The agricultural mowing device 2000 further includes a rear gauge wheel 2660 that is coupled to the adjustable shaft 2600 via, for example, a gauge frame 2670. The gauge wheel 2660 aids in adjusting the height of the weed-control units 2300 and 2400 over uneven terrain or weeds. It is also contemplated that the agricultural mowing device 2000 includes multiple gauge wheels instead of a single gauge wheel 2660. The gauge wheel 2660 is coupled to a depth adjuster 2680, which aids in adjusting the height of the weed-control units 2300 and 2400. In some implementations, the depth adjuster 2680 includes a spring-loaded element (not shown) such that the primary and secondary weed-control units 2300 and 2400 automatically adjust in height when passing over uneven terrain (e.g., the weed-control units 2300 and 2400 float up and down following contour of the terrain). Additionally or alternatively, the depth adjuster 2680 includes a motor drive unit (not shown). Additionally or alternatively, the depth adjuster 2680 includes a manual adjuster that manually positions the weed-control units 2300 and 2400 at fixed distances on the adjustable shaft 2600.

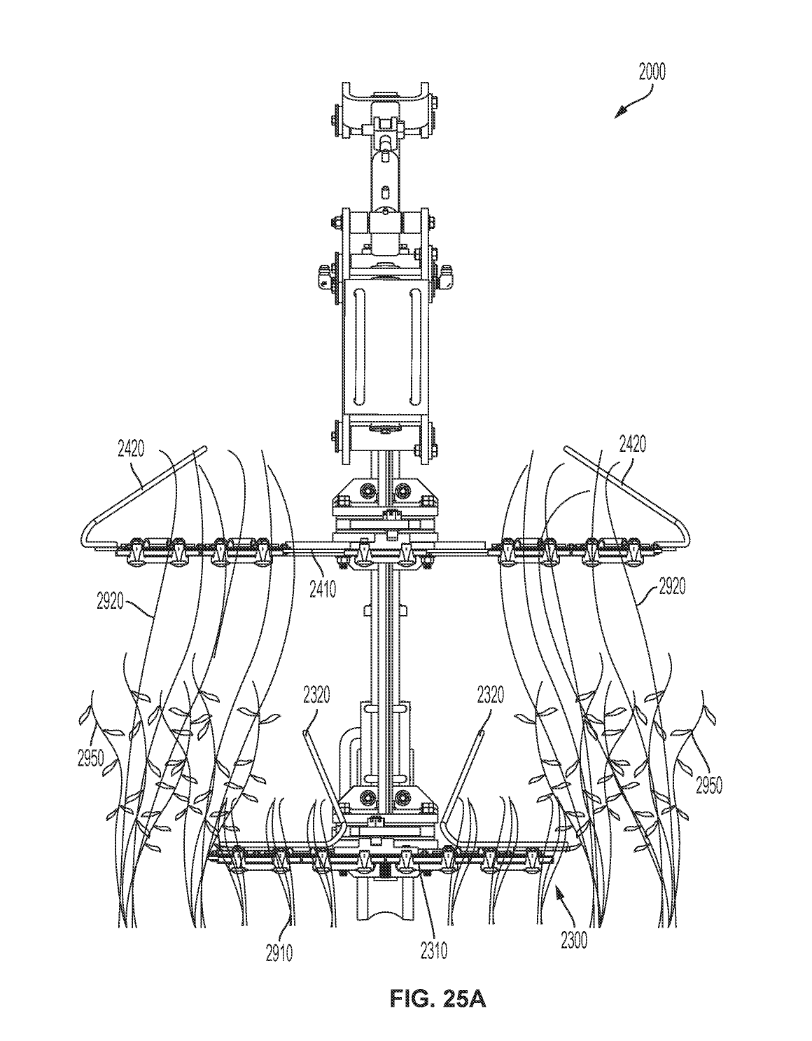

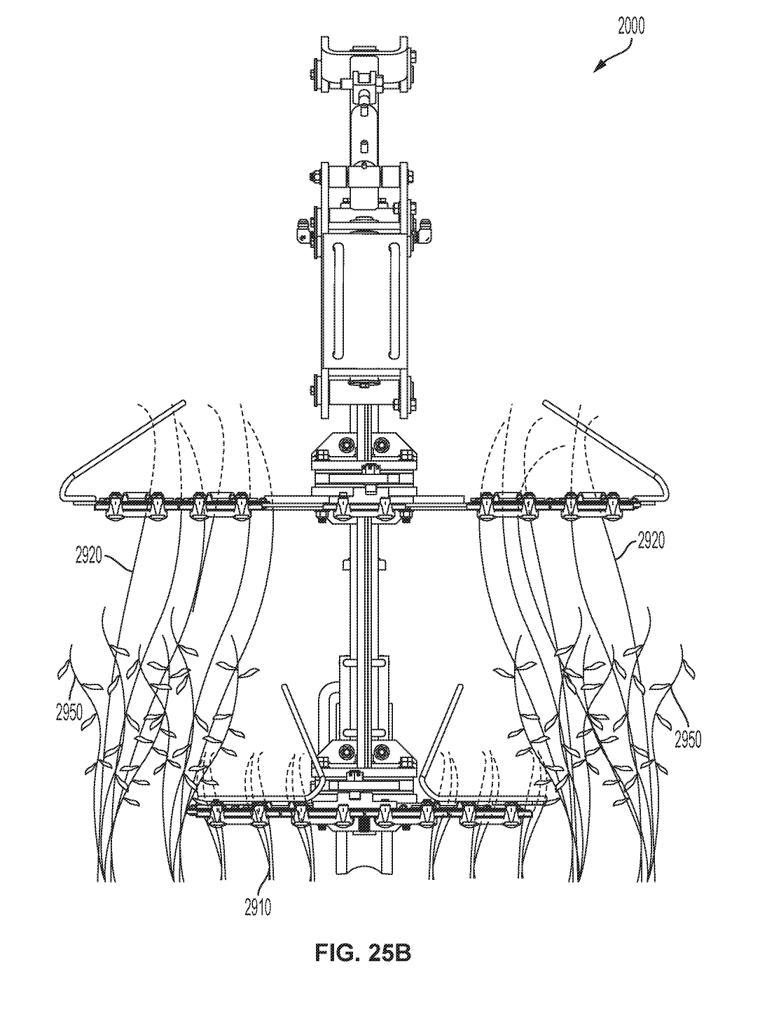

Referring to FIG. 22, the primary weed-control unit 2300 includes a cutting assembly 2310. Similarly, the secondary weed control unit 2400 includes a cutting assembly 2410. The cutting assemblies 2310 and 2410 may include rotating blades, oscillating blades, flail blades, a rotary cutter, a rotating cutter, or an oscillating cutter, or the like, or in any combination thereof. As an example, the cutting assemblies 2310 and 2410 each includes a plurality of sickles. In some embodiments, the cutting assembly 2310 of the primary weed control unit 2300 includes one set of sickles 2311 positioned along the entire length of the cutting assembly 2310. The cutting assembly 2410 of the secondary weed control unit 2400 includes two sets of sickles 2411 and 2412 located on opposite sides of the secondary weed control unit 2400. There is a gap between the two sets of sickles 2411 and 2412, such that a majority of the weeds being cut by the primary weed control unit 2300 are not cut twice up top by the secondary weed control unit 2400 (as best shown in FIGS. 25A-B).

Referring to FIGS. 25A-B, the primary weed-control unit 2300 also includes a pair of tapered deflectors 2320 positioned in front of and at opposite ends of the cutting assembly 2310 for guiding and lifting adjacent rows of planted matter 2950 away from the cutting assembly 2310. The secondary weed-control unit 2400 includes a pair of tapered deflectors 2420 located in front of and at opposite ends of the cutting assembly 2410 for guiding and pulling the unwanted material 2920 (e.g., weeds and/or regrowth) towards the cutting assembly 2410. The cutting assembly 2310 of the primary weed-control unit 2300 is narrow enough to fit between adjacent rows of planted matters. The cutting assembly 2410 of the secondary weed-control unit 2400 extends into the rows of planted matter 2950.

As best shown in FIG. 25A, prior to cutting, weeds 2910 can grow between adjacent rows of planted matter 2950. In addition, weeds 2920 can grow within the rows of planted matter 2950, which often grow at a higher height than the planted matter 2950. Turning to FIG. 25B, as the agricultural mowing device 2000 advances between adjacent rows of planted matter 2950, the primary weed-control unit cuts growing weeds 2910 between the rows of planted matter 2950 to clear a reduced or weed-free path. The secondary weed-control unit cuts growing weeds 2920 among the rows of planted matter 2950 to reduce re-growth.

Additionally or alternatively, the agricultural mowing device 2000 includes a sprayer input (not shown) with one or more sprayer input tubes that are coupled to an end of the weed-control unit for delivering weed-control and/or other substances. The weed-control substance is helpful in reducing and/or preventing the reappearance of weeds.

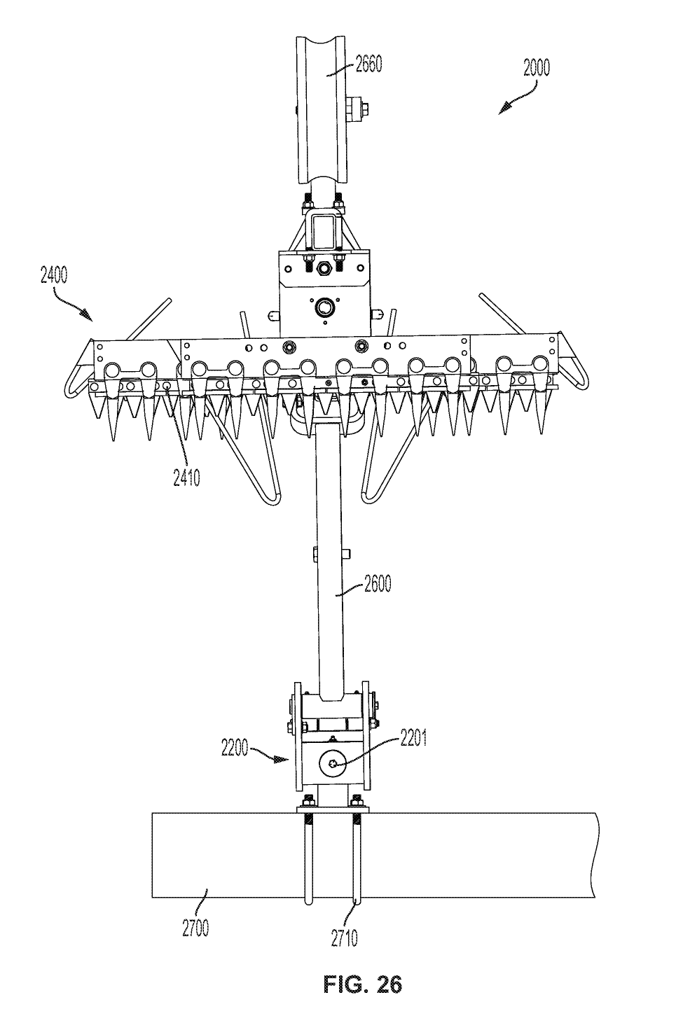

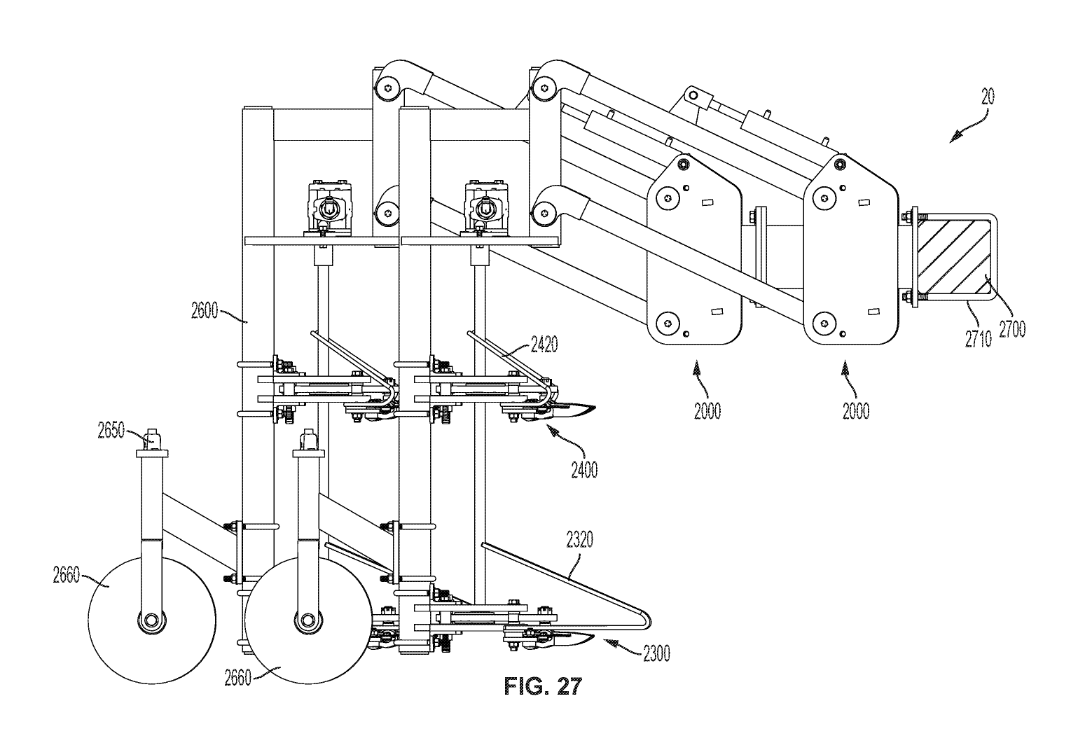

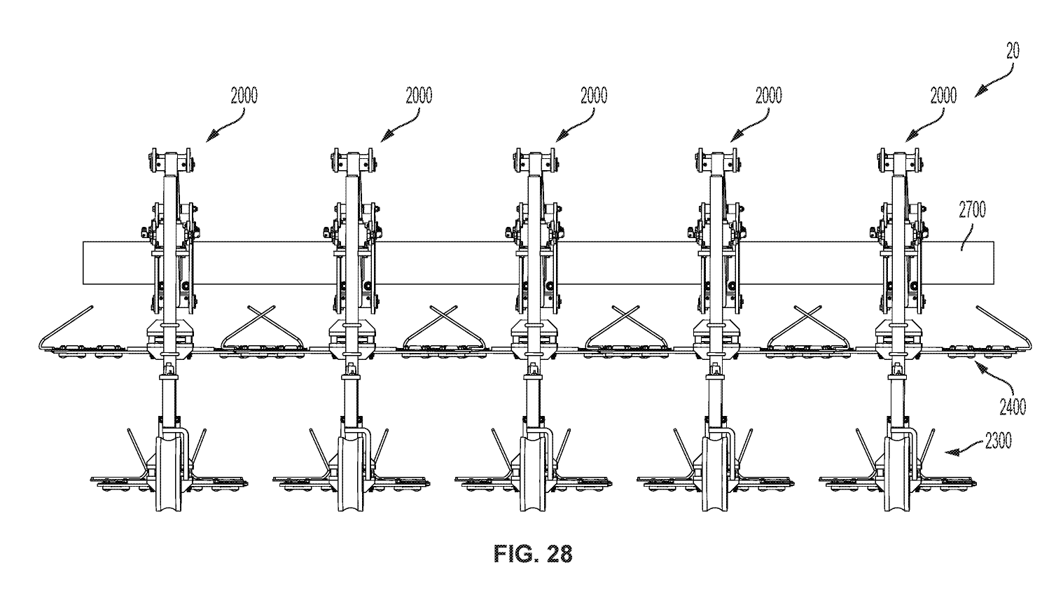

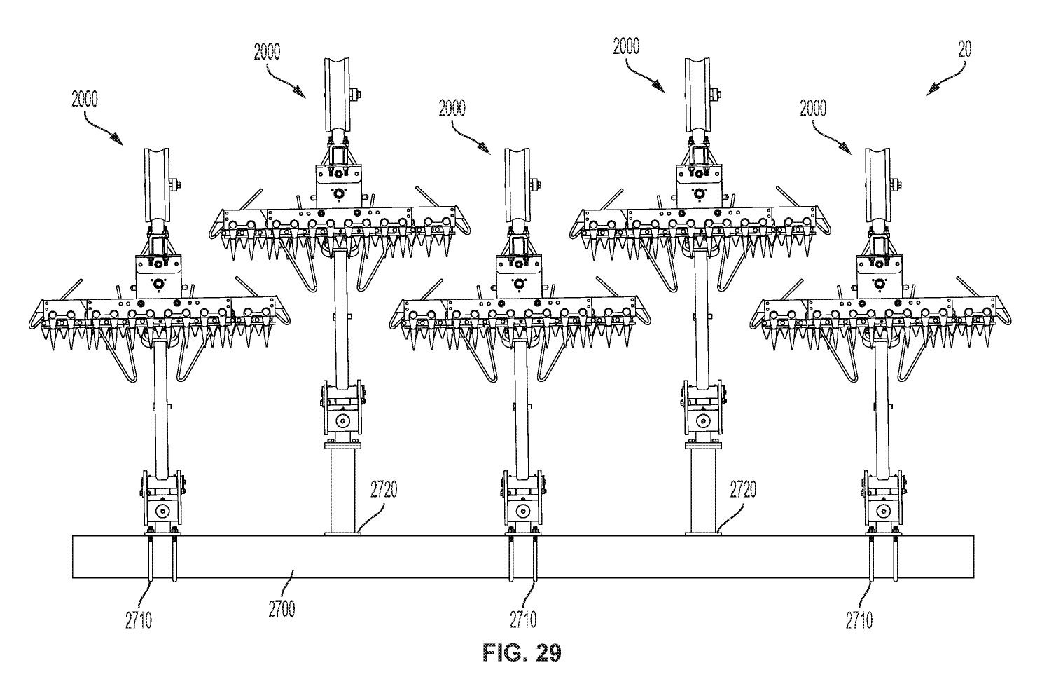

Referring to FIGS. 26-29, an agricultural system 20 has a plurality of agricultural mowing devices 2000 with respective primary and secondary weed-control units 2300 and 2400, for mowing multiple rows at the same time. Each agricultural mowing devices 2000 has a rear gauge wheel 2660 that is mounted to an adjustable shaft 2600. The agricultural mowing devices 2000 are coupled to one another via, for example, a mounting frame 2700. As best shown in FIG. 26, an agricultural mowing device 2000 is attached to the mounting frame 2700 via a pair of U-shaped bolts 2710, Alternatively, an agricultural mowing device 2000 is attached to the mounting frame 2700 via a mounting plate 2720 (FIG. 29). The agricultural mowing devices 2000 are individually driven by their respective motors 2650. Additionally or alternatively, the agricultural mowing devices 2000 are driven by a single motor that are coupled to each agricultural mowing device 2000 via, for example, a rotating belt (not shown). As such, the single motor drives simultaneously each of the agricultural mowing devices 2000. As best shown in FIG. 29, the agricultural mowing devices 2000 are spaced from one another and positioned more or less forward relative to one another in the direction of advancement of the agricultural system 20, such that portions of the respective secondary weed-control units 2400 overlap one another to provide better coverage of the planted crops.

Additionally or alternatively, the secondary weed-control unit is located on an ancillary mowing device that does not include a primary weed-control unit. The ancillary mowing device includes a vertically adjustable shaft that is coupled to the secondary weed-control unit for removing (e.g., cutting) weeds above planted crops growing among the planted crops. An ancillary system includes a plurality of ancillary mowing devices. The ancillary agricultural system aids a primary agricultural system (e.g., implementations illustrated in FIGS. 10-20) to cut regrowth among the rows of planted matter, where the primary agricultural system cuts rows of weeds closer to the ground between the rows of planted matter.

In addition to weed control, it is also contemplated that the agricultural devices and systems described above are capable of being broadly used in regenerative farming systems. For example, in a field of cash crops and living cover crops (e.g., a legume cover crop), the agricultural system supplies fertilizer to the cash crop via the nitrogen fixation of the legume. The agricultural mowing devices would be used to control weeds, but also to cut the cover crop so that the clippings decompose, thereby fertilizing the cash crop.

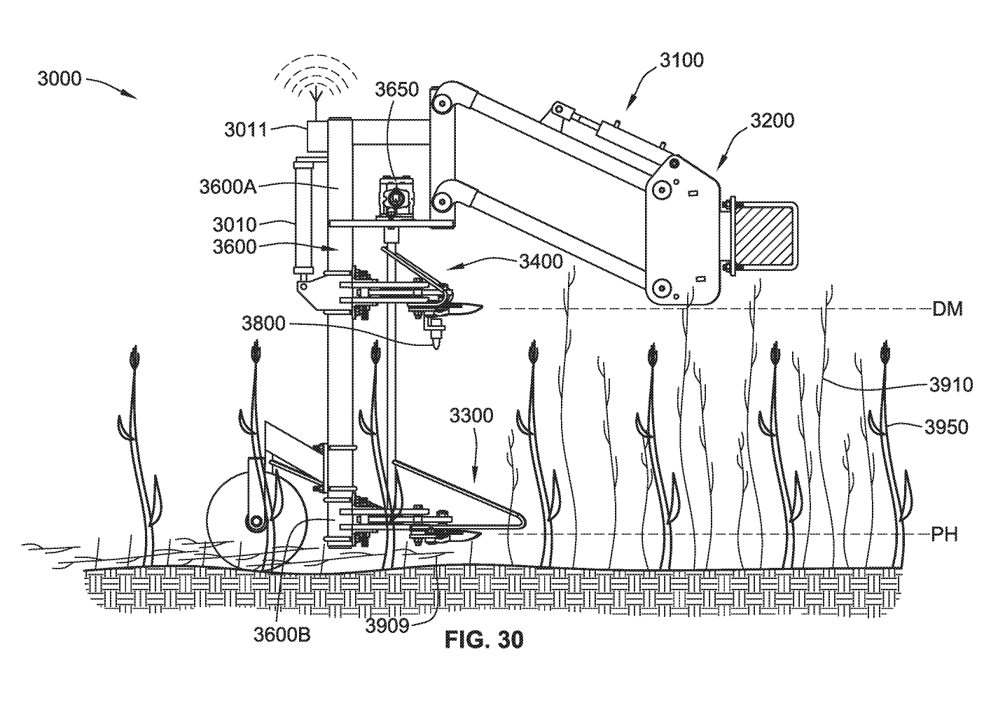

Referring to FIGS. 30-34, an agricultural mowing device 3000 includes a linkage assembly 3100 for attaching a cutting device to a towing vehicle (e.g., a tractor) via a mounting assembly 3200. The agricultural mowing device 3000 further includes a primary weed-control unit 3300 (also referred to as a primary cutting device) for cutting shorter plant material 3909 (e.g., weeds) between rows in a planted field of crops (e.g., corn, soybeans, etc.) and a secondary weed-control unit 3400 (also referred to as a secondary cutting device) for inter-row removal of unwanted material 3910 of a higher height than the shorter plant material 3909. The unwanted material includes, for example, tall weeds 3910 or other crops 3950 that grow among the rows in the planted field of crops and that generally grow at a higher height than the height of a desired planted crop in the row.

The agricultural mowing device 3000 is the same as or similar to implementations illustrated in FIGS. 10-29, having identical or similar components, except that the agricultural mowing device 3000 further includes a sensor 3800 for sensing planted matter 3910, 3950, including weeds, crops, and/or other materials, and is configured to automatically adjust at least the secondary weed-control unit 3400 to a desired cutting height. For example, the primary and secondary weed-control units 3300, 3400 are optionally driven by a single motor 3650 (which is similar or identical to the motor 2650 described above).

The agricultural mowing device 3000 includes a shaft 3600 having an upper end 3600A coupled to the linkage assembly 3100 for being towed in the filed between two adjacent rows of planted matter. The primary weed-control unit 3300 is mounted to a lower end 3600B of the shaft 3600 for cutting the shorter plant material 3909. The secondary weed-control unit 3400 is mounted near the upper end 3600A for cutting the taller plant material 3910, 3950. As described above in reference to other embodiments, the primary weed-control unit 3300 extends laterally from the shaft 3600 covering only a distance between two adjacent rows to cut the shorter plant material 3909 that grows between the two adjacent rows. As further described above in reference to other embodiments, the secondary weed-control unit 3400 extends laterally from the shaft 3600 to a distance covering at least a portion of at least one of the two adjacent rows for cutting the taller plant material 3910, 3950 that grows in the at least one of the two adjacent rows.

The height position of the secondary weed-control unit 3400 is adjusted along the shaft 3600 via a moving mechanism 3010, such as a hydraulic cylinder. According to other examples, the moving mechanism is an electric actuator, a pneumatic actuator, or any other powered actuator. The adjustment of the secondary weed-control unit 3400 is automatic and/or based on remote instructions from a controller and/or a human operator. According to one example, the instructions cause the hydraulic cylinder 3010 to move the secondary weed-control unit 3400 up or down along the shaft 3600 at a predetermined position relative to a sensed plant height. According to other examples, the height position of the secondary weed-control unit 3400 is adjusted in accordance with other parameters, including its tracked Global Positioning System (“GPS”) location in a field via a GPS unit 3011 (e.g., a transponder and/or receiver unit).

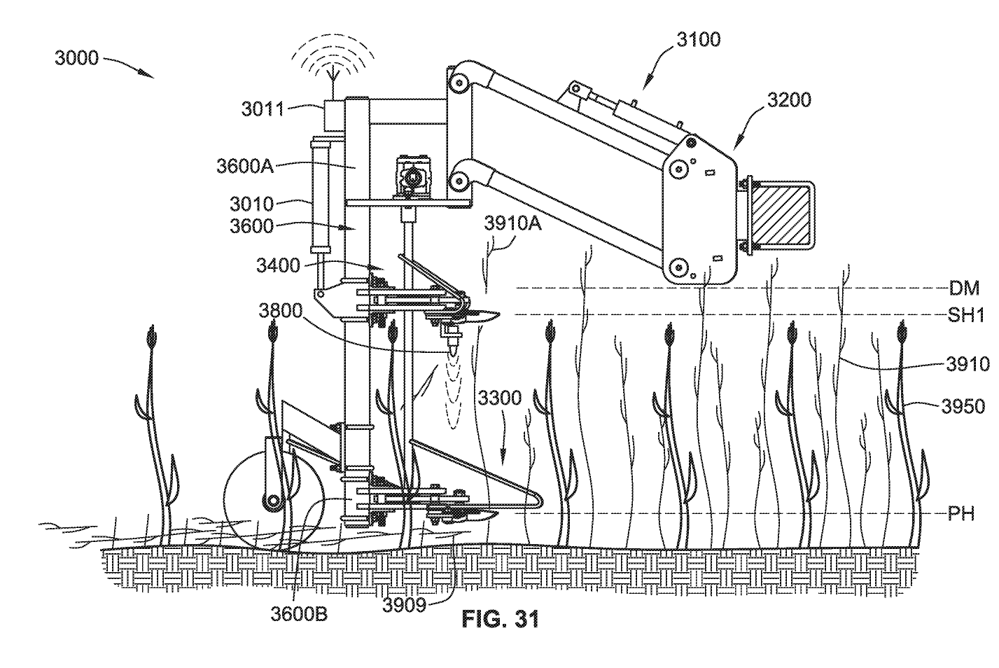

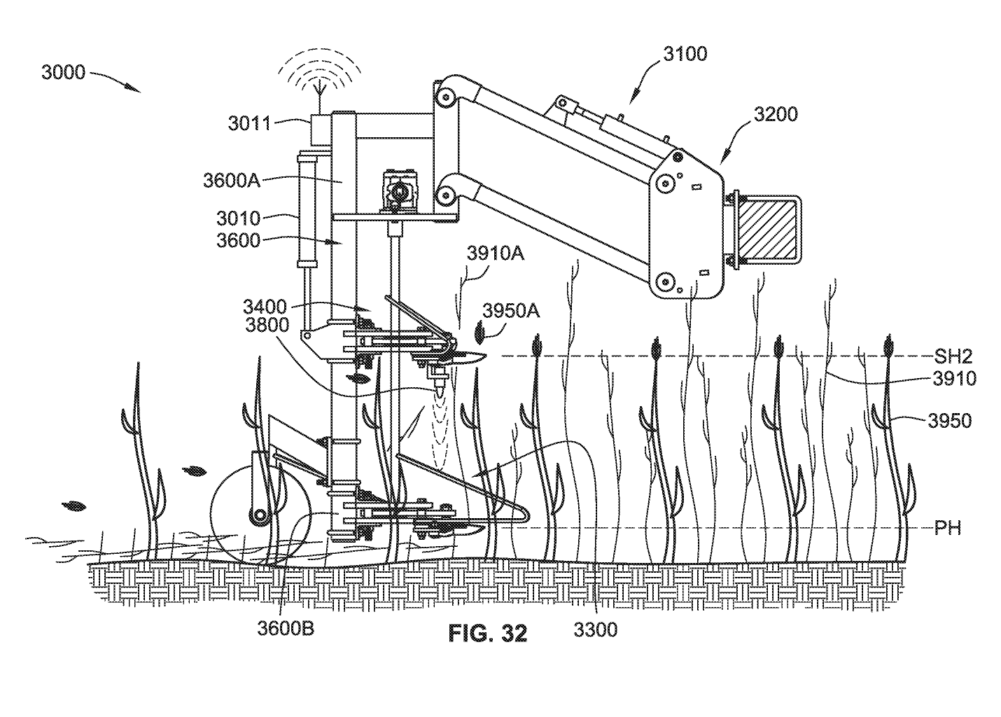

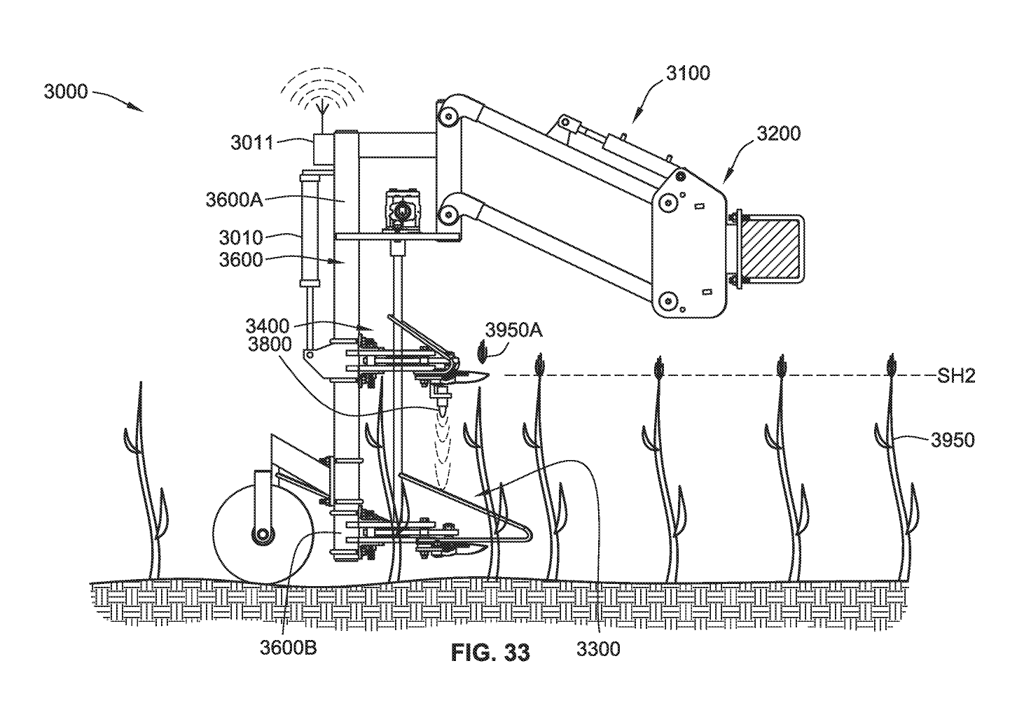

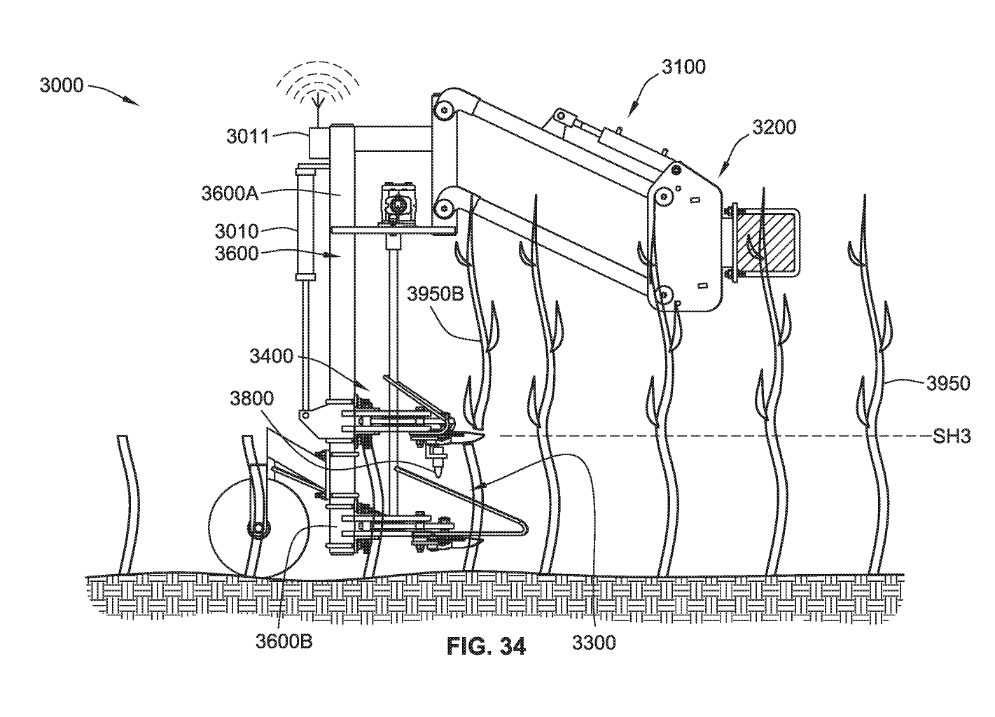

Initially, by way of example and as illustrated in FIG. 30, the primary weed-control unit 3300 cuts weeds 3909 at a primary height PH and the secondary weed-control unit 3400 is set at default height DH. Referring to FIG. 31, the sensor 3800 is activated to provide a sensing signal that causes the secondary weed-control unit 3400 to adjust to a first secondary height SH1 for cutting tops 3910A of the weeds 3910. As the agricultural mowing device 3000 advances through the field, both weed-control units 3300, 3400 simultaneously cut short weeds 3909 and tall weeds 3910. Referring to FIG. 32, the sensor 3800 provides a sensing signal that causes the secondary weed-control unit 3400 to adjust to a second secondary height SH2 for cutting tops 3950A of other tall crops 3950. Referring to FIG. 33, the secondary weed-control unit 3400 continues to cut the other tall crops 3950, while the primary weed-control unit 3300 stops cutting shorter weeds. Referring to FIG. 34, the sensor 3800 provides a sensing signal that causes the secondary weed-control unit 3400 to adjust to a third secondary height SH3 for cutting the tall crops 3950 closer to the bases of the crop.

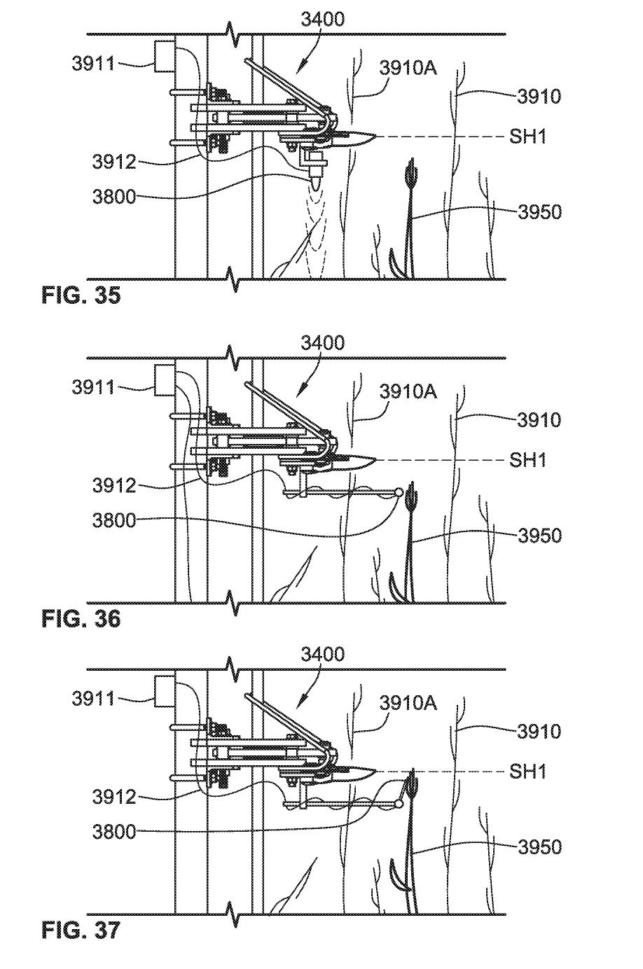

Referring to FIGS. 35-37, the sensor 3800 is illustrated in various exemplary forms and is optionally coupled to a controller 3911 via a communication cable 3912. The controller 3911 optionally provides electrical power and/or received a sensor signal for determining automatic height adjustment of the secondary weed-control unit 3400. Alternatively, the sensor 3800 is wirelessly coupled to the controller 3911 and/or additional controllers for providing sensor input in response to which the secondary weed-control unit 3400 is adjusted automatically and/or manually by a human operator. Referring to FIG. 35, the sensor 3800 is in the form of a proximity sensor that senses within a predetermined proximity the height of tall weeds 3910 to cut the tops 3910A. Referring to FIG. 36, the sensor 3800 is in the form of an electrical probe that senses a thicker tall crops 3950 and adjusts the secondary weed-control unit 3400, accordingly, to cut the tops 3910A of the thinner tall weeds 3910. Referring to FIG. 37, the sensor 3800 is in the form of a rotational gauge having a pole 391 that does not rotate when making contact with a weed 3900, which is not as firm as the firmer, thicker tall crops 3950. The rotation of the pole 391 provides the indication that differentiates between the weeds 3900 (which will not rotate the pole 391) and the tall crops 3950 (which will rotate the pole 391).

In an alternative embodiment, the primary weed-control unit 3300 includes its own sensor 3800 to automatically adjust the primary height PH for cutting the shorter plant material 3909. In this embodiment, either or both of the primary and secondary weed-control units 3300, 3400 are automatically adjusted in response to the sensed height by their respective sensors 3800. The automatic adjustment is continuous, changing the height of the primary or secondary weed-control units 3300, 3400 in accordance with varying height of the sensed plant material.

It will be evident to those skilled in the art that the invention is not limited to the details of the foregoing illustrated embodiment and that the present invention may be embodied in other specific forms without departing from the spirit or essential attributes thereof. For example, the present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An agricultural mowing device comprising:
a linkage assembly for attaching to a towing vehicle;
a shaft having an upper end coupled to the linkage assembly for being towed in a field between two adjacent rows of planted matter;
a primary cutting device mounted to a lower end of the shaft for cutting shorter plant material;
a secondary cutting device mounted near the upper end of the shaft for cutting taller plant material; and
a sensor for sensing a desired cutting height of the planted matter and being communicatively coupled to the primary cutting device or the secondary cutting device, the sensing causing an adjustment along the shaft of the respective one of the primary cutting device or the second cutting device to cut the planted matter at the desired cutting height.

2. The agricultural mowing device of claim 1, wherein the primary cutting device extends laterally from the shaft covering only a distance between the two adjacent rows for cutting the shorter plant material that grows between the two adjacent rows.

3. The agricultural mowing device of claim 1, wherein the secondary cutting device extends laterally from the shaft to a distance covering at least a portion of at least one of the two adjacent rows for cutting the taller plant material that grows in the at least one of the two adjacent rows.

4. The agricultural mowing device of claim 1, wherein the adjustment is automatic.

5. The agricultural mowing device of claim 4, wherein the automatic adjustment is continuously adjusted between a default cutting height, a first cutting height associated with a first type of plant matter, and a second cutting height associated with a second type of plant matter.

6. The agricultural mowing device of claim 1, wherein the adjustment is between a first cutting height associated with a first type of plant matter and a second cutting height associated with a second type of plant matter.

7. The agricultural mowing device of claim 1, wherein the adjustment is between a first cutting height associated with a first height of the planted matter and a second cutting height associated with a second height of the planted matter.

8. The agricultural mowing device of claim 1, wherein the sensor is selected from a group consisting of a proximity sensor, a rotational gauge sensor, and an electrical probe sensor.

9. The agricultural mowing device of claim 1, wherein each of the primary and secondary cutting devices has cutting members selected from a group consisting of a plurality of sickle knives, a plurality of rotatable blades, a plurality of oscillating blades, a plurality of flail blades, a rotary cutter, a rotating cutter, an oscillating cutter, or any combination thereof.

10. The agricultural mowing device of claim 1, further comprising at least one motor coupled to at least one of the primary and secondary cutting devices for driving respective cutting members, the at least one motor being selected from a group consisting of an electric motor, a hydraulic motor, an internal combustion engine, or any combination thereof.

11. An agricultural mowing device comprising:
a linkage assembly for attaching to a towing vehicle;
a shaft having an upper end coupled to the linkage assembly for being towed in a field between two adjacent rows of planted matter;
a cutting device mounted to the shaft for cutting plant material, the cutting device extending laterally from the shaft to a distance covering at least a portion of at least one of the two adjacent rows for cutting the plant matter that grows in the at least one of the two adjacent rows; and
a sensor for sensing a desired cutting height of the planted matter and being communicatively coupled to the cutting device, the sensing causing an automatic adjustment along the shaft of the cutting device to cut the plant matter at the desired cutting height.

12. The agricultural mowing device of claim 11, further comprising another cutting device mounted to the shaft lower than the cutting device, the another cutting device extending laterally from the shaft covering only a distance between the two adjacent rows for cutting plant matter that grows between the two adjacent rows.

13. The agricultural mowing device of claim 11, wherein the automatic adjustment is continuously adjusted between a default cutting height, a first cutting height associated with a first type of plant matter, and a second cutting height associated with a second type of plant matter.

14. The agricultural mowing device of claim 11, wherein the automatic adjustment is between a first cutting height associated with a first type of plant matter and a second cutting height associated with a second type of plant matter.

15. The agricultural mowing device of claim 11, wherein the sensor is selected from a group consisting of a proximity sensor, a rotational gauge sensor, and an electrical probe sensor.

16. A method for cutting plant matter with an agricultural mowing device, the method comprising:
attaching a linkage assembly to a towing vehicle;
advancing the linkage assembly in a field of planted matter with a shaft being positioned between two adjacent rows of the planted matter, the shaft having an upper end coupled to the linkage assembly;
cutting with a primary cutting device shorter plant material that grows between the two adjacent rows, the primary cutting device being mounted to a lower end of the shaft;
cutting with a secondary cutting device taller plant material that grows at least in part in at least one of the two adjacent rows, the secondary cutting device being mounted near the upper end;
sensing with one or more sensors a desired cutting height of the shorter plant material or the taller plant material; and
based on the sensing, automatically adjusting at least one of the primary cutting device or the secondary cutting device to the desired cutting height.

17. The method of claim 16, further comprising continuously adjusting at least one of the primary cutting device or the secondary cutting device based on varying height of the shorter plant material or the taller plant material.

18. The method of claim 16, further comprising simultaneously cutting with the primary cutting device and the secondary cutting device the respective short plant material and taller plant material.

19. The method of claim 16, further comprising operating at least one of the primary cutting device and the secondary cutting device with a motor selected from a group consisting of an electric motor, a hydraulic motor, an internal combustion engine, or any combination thereof.

20. The method of claim 16, further comprising cutting the shorter plant material and the taller plant material with cutting members of the respective ones of the primary cutting device and the secondary cutting device, the cutting members being selected from a group consisting of a plurality of sickle knives, a plurality of rotatable blades, a plurality of oscillating blades, a plurality of flail blades, a rotary cutter, a rotating cutter, an oscillating cutter, or any combination thereof.
